(19) United States
(12) Patent Application Publication
(10) Pub. No.: US 2026/0323247 A1
(43) Pub. Date: Oct. 15, 2026

(54) ELECTRONIC DEVICE AND METHOD FOR SWITCHING AURACAST ROLE BETWEEN DEVICES

(71) Applicant: Samsung Electronics Co., Ltd., Suwon-si (KR)

(72) Inventors: Harsh SHARMA, Bihar (IN); Gurumani Lakshmi Praneeth Juturu, Bangalore (IN); Hemant Kumar, Bihar (IN); Veerabhadrappa Chilakanti, Bangalore (IN); Pramod Reddy Serikar, Bengaluru (IN)

(21) Appl. No.: 19/685,548

(22) Filed: May 22, 2026

Related U.S. Application Data
(63) Continuation of application No. PCT/KR2026/002744, filed on Feb. 13, 2026.

(30) Foreign Application Priority Data
Feb. 18, 2025 (IN) 202541013920

(51) Int. Cl. H04W 4/06; H04W 76/14

(52) U.S. Cl. CPC H04W 4/06; H04W 76/14

(57) ABSTRACT

A method for switching an Auracast source includes detecting, by a first electronic device acting as an Auracast source device, a requirement to hand over the Auracast source role to any one of multiple second electronic devices; receiving device capability information from each of the second electronic devices and identifying a target second electronic device suitable for assuming the Auracast source role; and transferring an Auracast configuration setting of the first electronic device to the identified second electronic device to enable seamless switching of the Auracast source role between devices.

### CROSS-REFERENCE TO RELATED APPLICATIONS

This application is a continuation of International Application No. PCT/KR2026/002744 designating the United States, filed on Feb. 13, 2026, in the Korean Ministry of Intellectual Property Receiving Office and claiming priority to Indian Provisional Patent Application No. 202541013920, filed on Feb. 18, 2025, and Indian Complete Patent Application No. 202541013920, filed on Feb. 9, 2026, in the Indian Patent Office, the disclosures of each of which are incorporated by reference herein in their entireties.

### BACKGROUND

### Field

The disclosure relates to broadcasting and for example, relates to an electronic device and a method for switching auracast role between devices.

### Description of Related Art

Nowadays, low energy (LE) audio introduces broadcast audio to Bluetooth technology, a new feature that enables an audio transmitter to broadcast to an unlimited number of nearby Bluetooth audio receivers. The broadcast audio opens significant new opportunities for innovation, including a powerful new capability, e.g., auracast broadcast audio.

The LE audio operates in two modes. The first mode includes unicast streaming which is connection oriented. The second mode includes broadcast/auracast streaming which is connectionless oriented. In the case of auracast streaming, below mentioned steps are followed to start and listen to auracast streaming (media).

At operation 1, device 1, which is the auracast source (e.g., auracast transmitter), starts the auracast from Bluetooth settings (BT settings).

At operation 2, device 2, which is an auracast assistant, scans for a list of auracast sources available in corresponding BT settings.

At operation 3, the device 2, which is connected to a device 3 which is an auracast sink (e.g., auracast receiver), sends the auracast source details to the third device. Consequently, the auracast sink starts receiving the packets from a chosen auracast source.

At operation 4, the device 3, the auracast sink, receives auracast source information from the assistant, which starts receiving auracast source packet and rendering the same.

An advantage of the auracast is that once the process starts, any number of devices such as smart earphones connected with their respective assistant device can listen to the broadcast streaming at a public place, such as an airport, restaurant, bar, public hearing, meeting, or even in a family gathering. The user starts broadcasting with their device and all other members easily scan that auracast source in their assistant device and send the auracast to smart earphones to start receiving the audio packets. This gives a synchronized streaming experience to every user.

Further, multiple people may be listening to a particular broadcast. Consider a scenario where the battery of the broadcasting device gets drained, some technical glitch occurs or any other reason happens, due to which the ongoing broadcast stops streaming.

According to the related methodology, when the broadcasting device experiences an issue, the auracast stops or the streaming of the broadcast stops. Consequently, the smart earphones would no longer be able to listen to auracast. To listen to a new auracast, the user starts another auracast in another device by repeating the above-mentioned steps 1 through 4, every user in assistant user interface (UI) scans the auracast list and sends the same to the smart earphones, the smart earphones start capturing audio packets from new auracast source.

In an example, in a group of 5 to 10 users or more, the remaining users may be using an auracast sink device and listening to audio media content, which is being broadcasted (e.g., auracasted) by an auracast source device of one of the users. All the users may be synced with a particular auracast started by the one user. Consider a scenario when the auracast source device is facing technical issues or battery is draining or some problem occurs which may force shut down the source device. In that case, the auracast listening of every user may be stopped or every user may need to switch to another auracast to listen.

As of now, there is no way to transfer the current auracast source to another device. The only way to do this is for every user to manually identify a new device that takes up the auracast source role and start broadcasting (auracasting) the same media. Below are the operations needed to start a new auracast in place of the older auracast.

A new device capable of the auracast source role has been identified. Here, the device creates a new broadcast and starts it. (operation 1: creation).

Assistant devices may scan for the new broadcast ID. (operation 2: scanning).

Assistant devices may share this information of new broadcast to smart earphones (sink) again. (operation 3: smart earphones received new source).

If the new auracast is password protected, smart earphones may latch on to the new auracast after receiving the password (operation 4: music started in smart earphones).

A problem in the above-mentioned scenario is that all of the 5 to 10 users need to scan the new broadcast (auracast source) again in the assistant device and add the same to smart earphones. Therefore, if one action is required per user, then in the present example scenario 5 to 10 actions would be required. In real-time implementations, generally, four actions per user are required to listen to new private auracast.

FIG. 1 is a diagram 100 illustrating an auracast source, an auracast assistant, and an auracast sink, according to a related art. An unlimited number of in-range auracast receivers are able to join the auracast broadcast from a nearby auracast transmitter.

At operation 1, an auracast transmitter begins an auracast broadcast that includes advertisements, which provide auracast assistants with information about the broadcast (e.g., name, content, codec configuration, etc.), as well as one or more audio streams (e.g., left and right stereo audio streams).

At operation 2, the auracast assistants scan for the auracast advertisements and provide a user interface (UI) that enables users to select an auracast broadcast to join, similar to the UI commonly used to connect to Wi-Fi networks in public spaces.

At operation 3, once the auracast broadcast is selected, the auracast assistant provides the auracast receiver (e.g. headphones, earbud, hearing aid, etc.) the information it needs to join the auracast broadcast.

FIG. 2 is a line diagram 200 illustrating smart earphones losing auracast listening, after auracast source goes out, according to a prior art. The line diagram 200 illustrates the method of smart earphones losing the connection to auracast source.

At operation 1: the auracast source, start the auracast with an auracast name: “K-Pop Songs” and play the media content.

At operation 2: after starting the auracast, the auracast starts emitting BT packets related to auracast that is: extended advertisement packets, periodic advertisement packets, and broadcast isochronous group information along with media content wrapped in broadcast isochronous group (BIG).

At operation 3: two users who listen to auracast start scanning in his/her assistant device once the auracast name: “K-Pop Songs” appears in the scanning list, it selects that auracast source.

At operation 4: once the user selects the auracast name: “K-Pop Songs” in the assistant device, the device sends a command to smart earphones to start capturing auracast packets. That command is known as ADD_SOURCE.

At operation 5: when smart earphones receive ADD_SOURCE command, it asks mobile to share more information about the auracast name: “K-Pop Songs”. this extra information is known as PERIODIC_ADVERTISEMENT.

At operation 6: on the request of smart earphones, the assistant sends more information to smart earphones: it is known as PERIODIC_ADVERTISEMENT_SYNC_TRANSFER.

At operation 7: after PERIODIC_ADVERTISEMENT_SYNC_TRANSFER, the smart earphones capture the media content from the auracast “K-Pop Songs”. At this stage, the music starts rendering in smart earphones/buzz/earbud.

At operation 8: the auracast source named: “K-Pop Songs” stopped broadcasting. Extended advertisement (EA), periodic advertisement (PA), BIG everything got stopped.

At operation 9: once auracast got stopped, the smart earphones lost it and now no media is being played. The user A loses auracast.

At operation 10: once auracast stops, every user's experience gets lost. Now each user needs to perform operations from 1 to 7 again which is a burden to each user and there comes discontinuity in experience.

FIG. 3 is a diagram illustrating an example scenario 300 of a group of friends listening to music, using auracast, according to the related art. The example scenario 300 shows Mr Kim 302 sharing a common audio/video file over auracast. While Ahn 312, Jang 314, Mr G 316, Gonil 318, and others are listening to it using an assistant (mobile) and sink (smart earphones). When Mr Kim 302 goes out, everyone's auracast experience stops.

At operation 1: Mr Kim 302 started the auracast with the name: Mr Kim's auracast and password: BleSmart earphones @24.

At operation 2: Mr Kim's mobile started extended advertisement, periodic advertisement, and broadcast isochronous stream.

At operation 3, all four people (Ahn 312, MR G 316, Gonil 318, Jang 314) started looking for auracast on their respective mobiles.

At operation 4: each user, selected Mr Kim's auracast in assistant device: ADDSOURCE_SENT_TO_SMART EARPHONES.

At operation 5: as auracast started by Mr Kim 302 has a password, the smart earphones ask for the password: the user has to enter the password in assistant device: ENTER_PASSWORD.

At operation 6: after entering the password, the smart earphones may sync with auracast and start playing content shared over auracast: SMART EARPHONES _SYNCs_AND_STARTs_LISTENING AURACAST.

Each user needs to perform 4 operations. Further, there may be a huge gap in listening (continuity). There may be multiple redundant operations for the user. If the current auracast source device stops streaming for any reason. Then a new device has to be identified and start a new auracast, again, each user needs to perform 4 operations to get synced with the new auracast.

FIG. 4 is a diagram illustrating an example scenario 400 of a number of operations required to switch to a new source, according to the related art. The example scenario 400 shows when Mr Kim has to go out, the auracast is stopped. So Mr Jang 314 may start a new auracast so that the continued listening is achieved, and in that case, everyone(Ahn 312, MR G 316, Gonil 318) needs to perform 3-4 operations to listen to the new auracast source. If there are N users, then N*4 operations are performed to switch to the new auracast.

FIGS. 5A and 5B are diagrams illustrating an example scenario of the related method to switch to another auracast, according to the related art. FIG. 5A illustrates a scenario 500A when auracast source A goes off, and the user starts a new auracast (from source device B). The new auracast takes at least 3 redundant operations to sync with smart earphones as shown below. FIG. 5B illustrates a scenario 500B that after starting a new broadcast, each user needs to perform at least 3 operations to listen to a new auracast. As these are manual operations, continuity may break. There may be a huge gap in listening. The example scenario 500 shows two pairs of smart earphones synced with auracast source A, both were able to listen to music broadcasted from device A. Now, in both the smart earphones auracast source A is playing, to sync with auracast source B, each user has to perform at least 3 operations. So if the user wants to switch to another source, each user has to perform 3 operations, in the case of a protected source it requires 4 or more operations there may be a huge gap during the switch.

Once auracast Source 1 stopped broadcasting, all users (it may be 2, 20, or 200 users) were not able to listen to it. Further, the user is forced to start a new auracast Source 2:

All the users need to scan source 2 in their assistant devices.

Then select the device for smart earphones.

They may have to enter a password in case of encrypted auracast.

In a public gathering, informational audio/or any media was shared over auracast protocols using a device (mobile). now, the user wants to take out that mobile to use it for another purpose or the mobile goes out due to battery drain or technical issue. The mobile may search for another device that can be used as a broadcast source for streaming. Further, the mobile shares the broadcast information with the selected device, and the selected device starts the same broadcast. Every smart earphone syncs with broadcast as before. The users don't have to select a new broadcast source and get the original media details for streaming. Moreover, the users don't have to share the new broadcast details such as passwords, and don't have to go through the 4-5 manual operations to connect to the source individually. The users being connected to the old auracast source may not get interrupted in between the streaming.

Therefore, in view of the above-mentioned problems, it is advantageous to provide an improved system and method that can address the above-mentioned problems and limitations associated with auracast continuity.

### SUMMARY

According to an example embodiment of the present disclosure, disclosed herein is a method for switching an Auracast source among a plurality of electronic devices. The method includes: detecting, by a first electronic device playing an Auracast source role of an Auracast source device, an operational requirement to hand over the Auracast source role to one of a plurality of second electronic devices; receiving device capability information from each of the plurality of second electronic devices, identifying a target second electronic device for the handover, and transferring an Auracast configuration setting of the first electronic device to the target second electronic device to switch the Auracast source role from the first electronic device to the target second electronic device.

According to an example embodiment of the present disclosure, disclosed herein is a method for switching an Auracast source role among a plurality of electronic devices. The method includes: detecting, by a first electronic device, a requirement to switch the Auracast source role based on one or more conditions including device status, Bluetooth signal strength, battery availability, and/or an input; broadcasting a packet indicating the requirement, scanning electronic devices that advertise willingness to accept the Auracast source role, receiving device capability information from the advertising electronic devices, selecting a second electronic device based on specified selection criteria, transmitting one or more Auracast source configuration parameters to the selected second electronic device, and disabling Auracast source transmission on the first electronic device upon confirmation that the second electronic device has successfully initialized the broadcasting Auracast source role.

According to an example embodiment of the present disclosure, disclosed herein is a method for switching an Auracast source role between electronic devices. The method includes: determining, by a first Auracast source device, to switch an Auracast source role of a broadcaster to a second Auracast source device; transmitting a request to one or more nearby electronic devices for taking up the Auracast source role, receiving a reply in response to the request, determining the second Auracast source device among the one or more nearby electronic devices based on the reply, transmitting Auracast source information to the determined second Auracast source device, and initiating, by the second Auracast source device, broadcasting of media based on receiving the Auracast source information.

According to an example embodiment of the present disclosure, disclosed herein is a system for switching Auracast source among a plurality of electronic devices. The system includes: a memory; and at least one processor, comprising processing circuitry, in communication with the memory, wherein at least one processor, individually and/or collectively, is configured to cause the system to: detect, using a first electronic device playing an Auracast source role of an Auracast source device, an operational requirement to hand over the Auracast source role to one of a plurality of second electronic devices, and to receive device capability information from each of the plurality of second electronic devices; identify a target second electronic device for the handover and to transfer an Auracast configuration setting of the first electronic device to the target second electronic device for switching the Auracast source role from the first electronic device to the target second electronic device.

According to an example embodiment of the present disclosure, disclosed herein is a system for switching an Auracast source role among a plurality of electronic devices. The system includes: a memory; and at least one processor, comprising processing circuitry, in communication with the memory, wherein at least one processor, individually and/or collectively, is configured to cause the system to: detect, using a first electronic device, a requirement to switch the Auracast source role based on one or more conditions including device status, Bluetooth signal strength, battery availability, and/or a user input, and to broadcast a packet indicating the requirement to a plurality of electronic devices; scan electronic devices advertising willingness to accept the Auracast source role, receive device capability information from the plurality of electronic devices, select a second electronic device based on specified selection criteria, transmit one or more Auracast source configuration parameters to the second electronic device, and disable Auracast source transmission on the first electronic device upon confirmation that the second electronic device has successfully initialized the broadcasting Auracast source role.

According to an example embodiment of the present disclosure, disclosed herein is a system for switching an Auracast source role between electronic devices. The system includes: a memory; and at least one processor, comprising processing circuitry, in communication with the memory, wherein at least one processor, individually and/or collectively, is configured to cause the system to: determine, using a first Auracast source device, to switch an Auracast source role of a broadcaster to a second Auracast source device, and to transmit a request to one or more nearby electronic devices for taking up the Auracast source role; receive a reply from the one or more nearby electronic devices in response to the transmitted request, determine the second Auracast source device based on the reply, transmit Auracast source information to the second Auracast source device, and initiate, using the second Auracast source device, broadcasting of media based on receiving the Auracast source information.

To further illustrate the advantages and features of the present disclosure, a more detailed description may be rendered by reference to various example embodiments thereof, which are illustrated in the appended drawings. It will be appreciated that these drawings depict example embodiments and are therefore not to be considered limiting its scope. The disclosure may be described and explained with additional specificity and detail with the accompanying drawings.

### BRIEF DESCRIPTION OF THE DRAWINGS

The foregoing and other aspects, features and advantages of certain embodiments of the present disclosure will be more apparent from the following detailed description, taken in conjunction with the accompanying drawings, wherein like reference numerals refer to like elements, and in which:

FIG. 1 is a diagram illustrating auracast source, assistant, and sink, according to a prior art;

FIG. 2 is a diagram illustrating smart earphones losing auracast listening, after auracast Source Goes Out, according to the prior art;

FIG. 3 is a diagram illustrating an example scenario of a group of friends listening to music, using auracast, according to the prior art;

FIG. 4 is a diagram illustrating an example scenario of a number of operations required to switch to a new source, according to the prior art;

FIGS. 5A and 5B are diagrams illustrating an example scenario of the related method to switch to another auracast, according to the prior art;

FIG. 6 is a diagram illustrating an example environment 600 that may include the first electronic device 602 operating in an Auracast source role, according to an example embodiment;

FIG. 7 is a block diagram illustrating an example configuration of the system, according to an example embodiment;

FIG. 8 is a flowchart illustrating an example method for switching Auracast source among a plurality of electronic devices, according to an example embodiment;

FIG. 9 is a flowchart illustrating example operations for identifying a potential electronic device capable of assuming an Auracast source role, according to an example embodiment;

FIG. 10 is a flowchart illustrating example operations for identifying potential devices capable of becoming a new Auracast source, according to an example embodiment;

FIGS. 11A and 11B are flowcharts illustrating an example method for switching Auracast source among a plurality of electronic devices, according to an example embodiment;

FIGS. 12A and 12B are signal flow diagrams illustrating example operations for end-to-end procedure for switching an Auracast source role from a current Auracast source to a successor device while maintaining continuity for one or more listening devices, according to an example embodiment;

FIG. 13 is a flowchart illustrating example operations for switching an Auracast source role from a first electronic device (current Auracast source) to a second electronic device, according to an example embodiment;

FIG. 14A is a timing diagram illustrating an example timing structure of a Broadcast Isochronous Group (BIG) event, during which the broadcasting module may transmit a sequence of Broadcast Isochronous Stream (BIS) PDUs, according to an example embodiment;

FIG. 14B is a diagram illustrating an example structure of a BIG Control PDU, which may include a Header, a Payload, and an optional Message Integrity Check (MIC), according to an example embodiment;

FIG. 15 is a signal flow diagram illustrating example operations in which an Auracast session may be transitioned from a current Auracast source to a successor device while preserving listening continuity for a plurality of electronic devices, according to an example embodiment;

FIGS. 16A and 16B are diagrams illustrating an example of how a Broadcast Isochronous Group (BIG) event may be used by the broadcasting module to indicate a change in Auracast source information during dynamic reconfiguration, according to an example embodiment;

FIG. 17 is a flowchart illustrating an example method that may describe a direct request reply takeover procedure for switching an Auracast source role between electronic devices, according to an example embodiment;

FIG. 18 is a diagram illustrating an example broadcast source architecture showing modifications that may be implemented at an Auracast broadcast source, according to an example embodiment;

FIG. 19 is a block diagram illustrating example modifications at the broadcast sink device, according to an example embodiment;

FIG. 20 is a signal flow diagram illustrating example call flow describing how Auracast broadcasting may be initiated on a second electronic device using Auracast parameters transferred from a first electronic device, according to an example embodiment;

FIG. 21 is a signal flow diagram illustrating example signal flow for starting an Auracast broadcast across an Application Layer (UI), a BT Host Layer and a BT Controller Layer, according to an example embodiment; and

FIG. 22 is a signal flow diagram illustrating example call flow illustrating how a first electronic device and a second electronic device may cooperate to initiate a new Auracast broadcast and transfer complete host-layer and controller-layer configurations in a coordinated manner, according to an example embodiment.

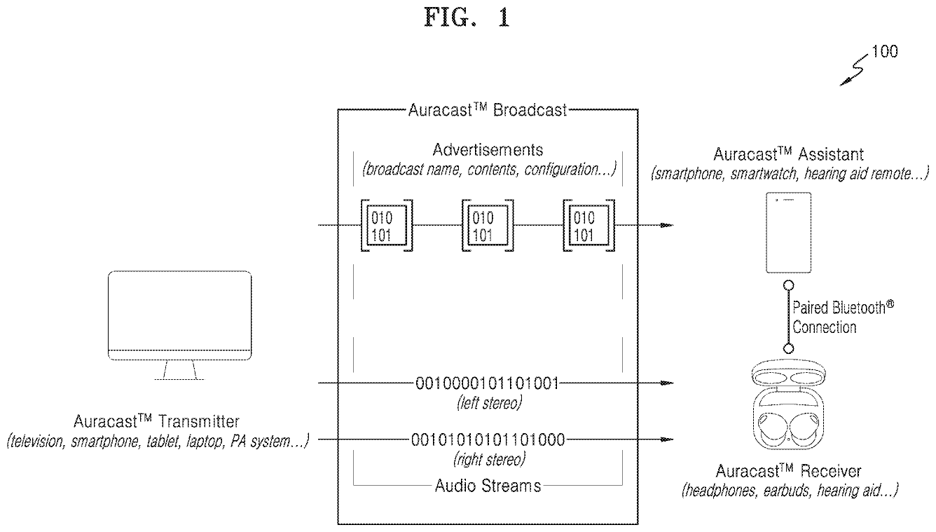

### DETAILED DESCRIPTION

Reference may now be made to various example embodiments and specific language may be used to describe the same. It may nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It may be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to various example “embodiments.” It should be understood that an embodiment is an example of a possible implementation of any features and/or elements of the present disclosure. Various example embodiments have been described for the purpose of explaining one or more of the potential ways in which the specific features and/or elements of the disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of various embodiments and therefore should not necessarily be taken as limiting factors to the disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure may be described below in greater detail with reference to the accompanying drawings.

The present disclosure may refer to current auracast source device needing to send its auracast configuration and other parameters to another device and then other device may play the same auracast as the current one. The method for the same involves a phase 1 for selecting the next auracast source capable device and making connection between the first auracast source device and a new device, e.g., a source capable device or the second device. In an example, the first auracast source device and the new device may not be connected directly, and the configuration may be shared as a part of BLE advertisement. In an example, the first auracast source device and the new device may not be connected at all, and both devices may communicate with a server to exchange configuration. The phase 1 used for the current auracast source need to select a potential source that can continue the current auracast and keep going. Further, in phase 2, after the next auracast source capable device is selected, current auracast device may share its auracast configuration with it.

The aforementioned may be achieved using at least one of an example method 1 or an example method 2. In an embodiment, the first auracast source and the selected auracast source capable device is connected over BT. In method 1, a source may send a command to a sink, and the sink may send that command to an assistant to accept source role. Method 1 is explained further below:

Current auracast device may broadcast a packet saying that the packet requires next source device. The sink may receive that packet.

The sink may tell the respective assistant that there is a requirement for the source role.

The assistant may start advertising saying I want to accept the source role.

The assistant may advertise a few of its information regarding the device and BT: received signal strength indication (RSSI), battery level, media player name, and internet availability.

The Source may scan and select a particular device.

Further, in method 2: the source and other nearby devices may scan and advertise, other devices may send a request to the current source to share auracast details. The method 2 is explained below: Newly selected device may start auracasting on its own . . . [it will create its own broadcast/auracast].

Newly selected device may send its Broadcast Id & name details to first auracast source device.

First auracast source may broadcast the details shared by newly selected device (2nd device) that may refer, for example, to, new Broadcast Id & Broadcast name may be published [broadcasted or auracasted] by the first auracast source.

All the sink devices listening to the first auracast source may read the message.

All the sink devices may stop listening to the first auracast source and may start listening to newly selected device's auracast.

In an example, the user referring to a situation where a Device A (auracast Source) is broadcasting an audio content with the ID: “Mr. Veera's auracast” and password is: BleSmart earphones @24. If the source device A is not able to broadcast (auracast). Now, the user starts a new auracast in another source device B. If the same auracast as device A above is started in device B, with same ID, password, and internal auracast's configurational details, this is referred to as auracast continuity. Excerpts: device A's auracast is now being used in device B.

TO-BE case: If there is some issue in the current auracast source (device 1), the user deep copies the auracast information to another device and that device starts a new auracast with the exact same configuration and all as the previous auracast, so that smart earphones are not able to differentiate whether audio packet is coming from (device 1) or new device. The smart earphones continue listening to new auracast assuming it is coming from the same device.

But in the background, auracast source device has changed. In the present disclosure, the Device 1 (Current) auracast configurational parameter is shared with other device (Device 2). The Device 2 starts a new auracast with the same parameters as the Device 1. The Smart earphones are not able to differentiate the aforementioned transition. The smart earphones keep listening to auracast, although now, the audio packet is coming from the device 2. The streaming does not stop, or the assistant may not have to scan again, as it may look like the previous broadcast to smart earphones.

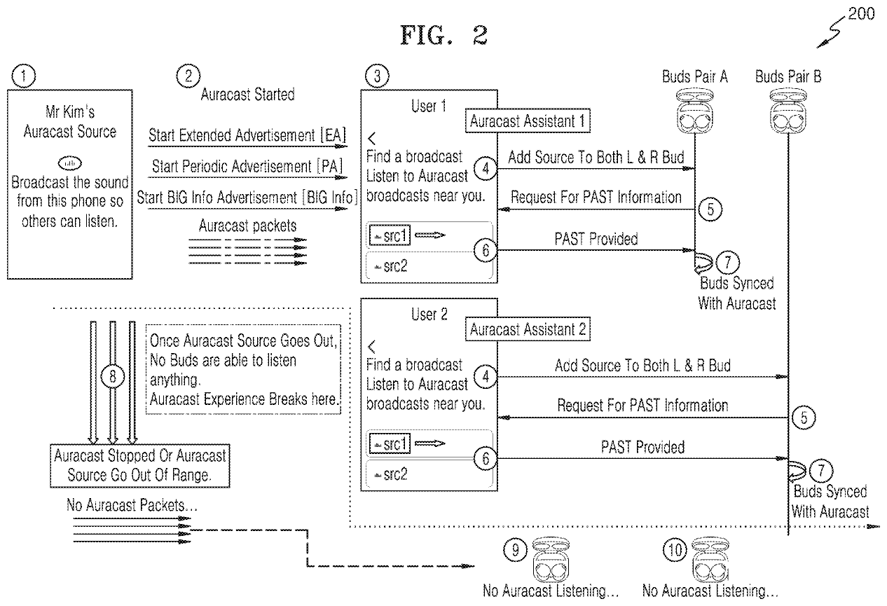

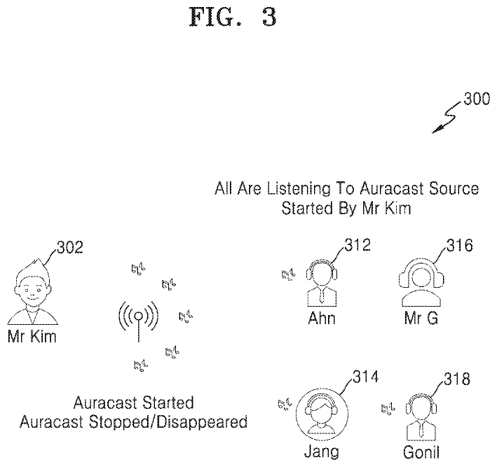

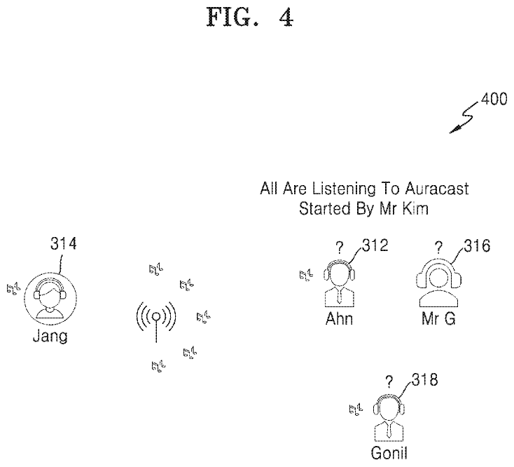

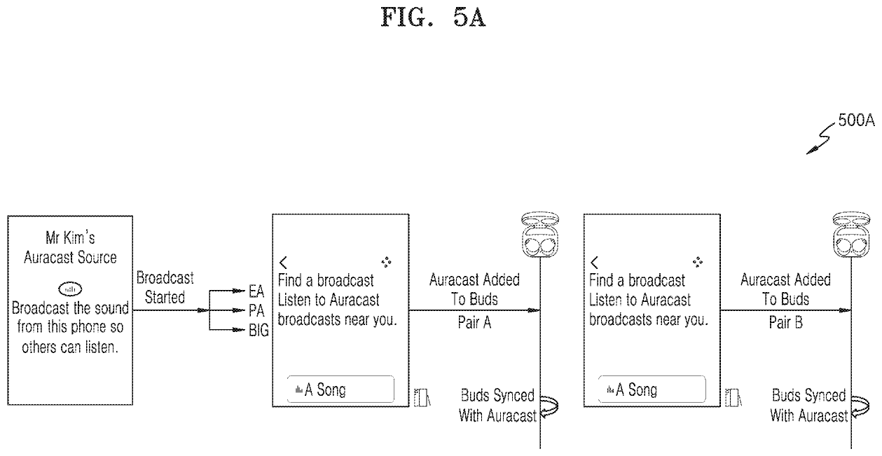

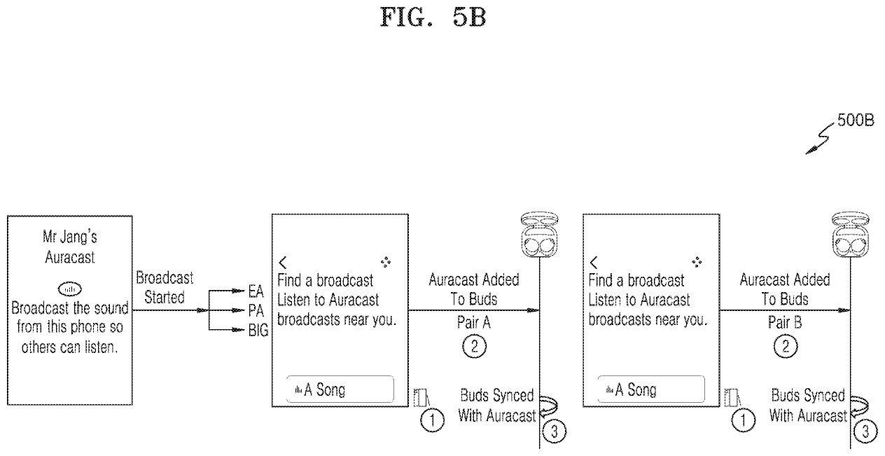

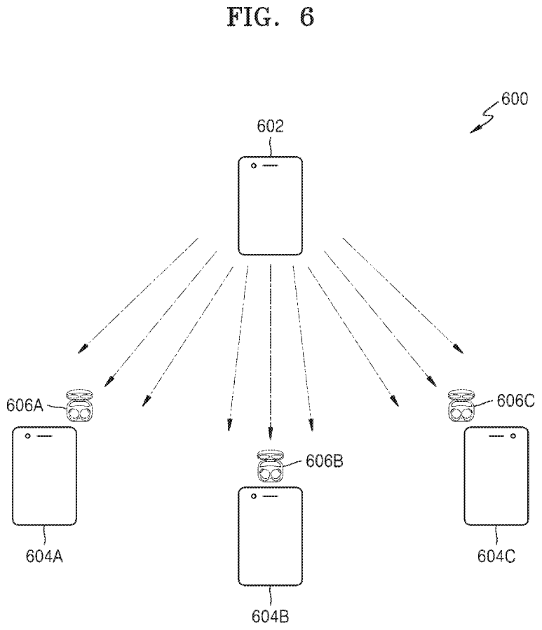

FIG. 6 is a diagram illustrating an example environment 600 that may include the first electronic device 602 operating in an Auracast source role, according to an example embodiment. The first electronic device 602 may initiate and broadcast Auracast audio streams to a plurality of nearby electronic devices. According to the present disclosure, a system that may be incorporated in the first electronic device 602 may be capable of changing the role of the Auracast source without disrupting the broadcast of Auracast data packets. Details of such a system may be explained with reference to FIGS. 2 and 3.

The example environment 600 further illustrates a plurality of second electronic devices 604A-604C that may be capable of connecting with the first electronic device 602. These second electronic devices 604A-604C may also be capable of assuming an Auracast source role when required. For instance, each second electronic device 604A-604C may advertise its availability, capability, or readiness to take over the Auracast broadcast when triggered by conditions such as battery constraints, user intent, or connectivity requirements.

FIG. 6 illustrates that each second electronic device 604A-604C may be connected to corresponding sink devices 606A-606C over a bluetooth low energy (BLE) link. Devices 606A-606C may be representative of Auracast sinks devices 606A-606C capable of receiving and rendering Auracast audio packets. By way of example, devices 604A-604C may be smartphones, tablets, or similar computing devices, and devices 606A-606C may be earphones, headphones, earbuds, speakers, or other audio accessories capable of receiving Auracast signals.

The second electronic devices 604A-604C may provide configuration details to their respective sink devices 606A-606C to ensure proper reception of Auracast audio. Such configuration details may include periodic advertisement synchronization information, broadcast identifiers, codec or stream parameters, and authentication information. Once synchronized, each sink device 606A-606C may seamlessly render the audio stream originating from the first electronic device 602 or another device assuming the source role.

FIG. 6 illustrates an environment in which Auracast content may be continuously played across multiple devices, and where the Auracast source role may be dynamically transferred among capable devices without disrupting ongoing audio playback. FIG. 6 also illustrates an example scenario 600 in which a group of users, such as a group of friends, may wish to play and listen to the same Auracast broadcast collaboratively. One user may initially create and broadcast the Auracast stream, and the others may listen to the content. If the broadcast stops on the originating user's device, such as due to battery discharge, the system may require a mechanism to seamlessly switch the Auracast source role to another device so that all users may continue receiving the same Auracast content without disruption. With the inclusion of the assistant in the first electronic device 602, the system may intelligently manage such role transitions, ensuring that the sink devices 606A-606C continue receiving uninterrupted Auracast audio packets and preserving session continuity even in dynamic group-listening scenarios.

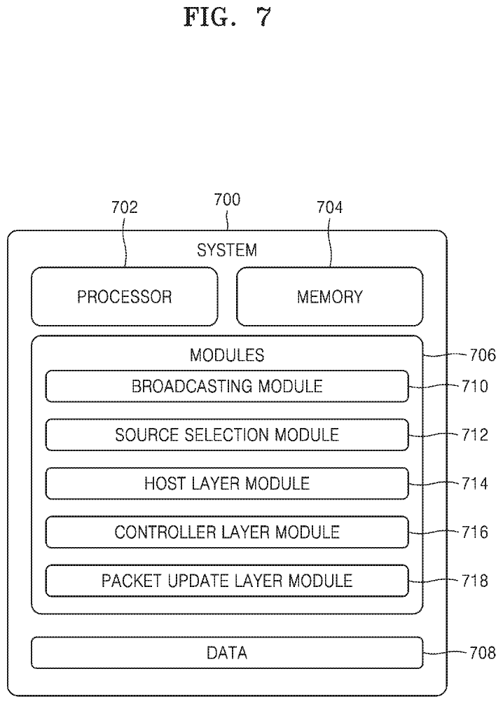

FIG. 7 is a block diagram illustrating an example configuration of the system 700, according to an example embodiment. The system 700 may include different components that operate synergistically to optimize an audio experience. For instance, the system 700 may include a processor (e.g., including processing circuitry) 702, a memory 704, module(s) (e.g., including various circuitry and/or executable program instructions) 706, and data 708. The memory 704, in one example, may store the instructions to carry out the operations of the modules 706. The modules 706 and the memory 704 may be coupled to the processor 702.

The processor 702 may include various processing circuitry and can be a single processing unit or several units, all of which could include multiple computing units. The processor 702 may be implemented as one or more microprocessors, microcomputers, microcontrollers, digital signal processors, central processing units, state machines, logic circuitries, and/or any devices that manipulate signals based on operational instructions. Among other capabilities, the processor 702 is configured to fetch and execute computer-readable instructions and data stored in the memory 704. Thus, the processor 702 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 704 may include any non-transitory computer-readable medium known in the art including, for example, volatile memory 704, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The module(s) 706, amongst other things, may include routines, programs, objects, components, data structures, etc., which perform particular tasks or implement data types. The modules 706 may also be implemented as, signal processor 702(s), state machine(s), logic circuitries, and/or any other device or component that manipulated signals based on operational instructions.

The modules 706 can be implemented in hardware, instructions executed by a processing unit, or by a combination thereof. The processing unit can comprise a computer, a processor, such as the processor 702, a state machine, a logic array, or any other suitable devices capable of processing instructions. The processing unit can be a general-purpose processor 702 which executes instructions to cause the general-purpose processor 702 to perform the required tasks or, the processing unit can be dedicated to performing the required functions. In an embodiment of the present disclosure, the modules 706 may be machine-readable instructions (software) which, when executed by a processor 702/processing unit, perform any of the described functionalities. Further, the data serves, amongst other things, as a repository for storing data processed, received, and generated by one or more of the modules 706. The data 708 may include information and/or instructions to perform activities by the processor 702.

The module(s) 706 may perform different functionalities which may include, but may not be limited to, optimizing the input audio. Accordingly, the module(s) 706 may include a broadcasting module 710, a source selection module 712, a host layer module 714, a controller layer module 716, and a packet update module 718. In one example, the at least one processor 702 may be configured to perform the operation by actuating the aforementioned module(s) 706.

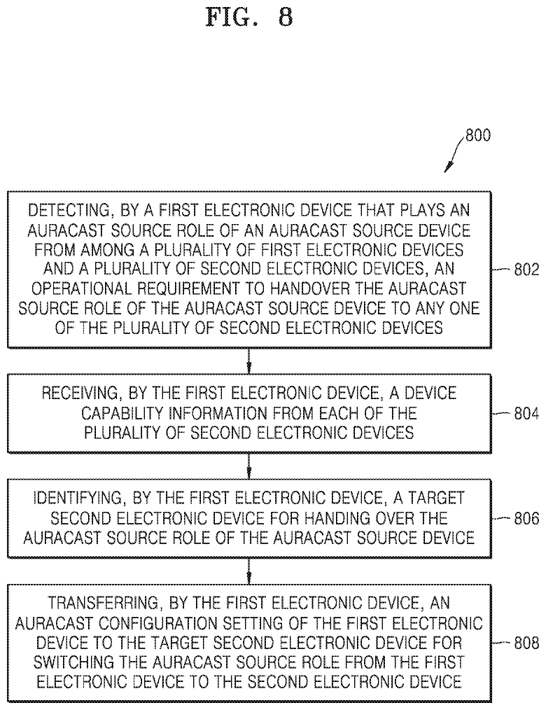

Details of the working of the system 700 will be explained in greater detail below with reference to FIG. 8.

FIG. 8 is a flow chart illustrating an example method 800 for switching Auracast source among a plurality of electronic devices, according to an example embodiment. The order in which the method operations are described below is not intended to be construed as a limitation, and any number of the described method operations can be combined in any appropriate order to execute the method or an alternative method. Additionally, individual operations may be deleted from the method without departing from the spirit and scope of the subject matter described herein.

The method 800 can be performed by programmed computing devices, for example, based on instructions retrieved from non-transitory computer readable media. The computer readable media can include machine-executable or computer-executable instructions to perform all or portions of the described method. The computer readable media may be, for example, digital memories, magnetic storage media, such as magnetic disks and magnetic tapes, hard drives, or optically readable data storage media.

In an example, the method 800 may be performed partially or completely by the system 700 shown in FIG. 7.

At operation 802, the system 700 inside the first electronic device 602 may detect an operational requirement to handover the Auracast source role of the Auracast source device to any one of a plurality of second electronic devices 604A-604C. Such an operational requirement may arise due to battery depletion, connectivity degradation, overheating, user-initiated switching, or other internal parameters indicating that the first electronic device 602 may no longer reliably continue Auracast broadcasting. The assistant incorporated within the first electronic device 602 may further assist system 700 in determining the necessity of initiating the handover.

At operation 804, the system 700 inside the first electronic device 602 may receive device capability information from each of the plurality of second electronic devices 604A-604C. The device capability information may include transmission capabilities, codec compatibility, battery level, processing availability, LE Audio feature support, or environmental metrics such as signal strength. The second electronic devices may provide such information either proactively or upon request initiated by system 700.

At operation 806, the system 700 inside the first electronic device 602 may identify a target second electronic device, such as the 604A from among the plurality of second electronic devices 604A-604C for handing over the Auracast source role. The identification may be based on analyzing the capability information received in operation 804. The system 700 may evaluate the second electronic devices using one or more criteria such as higher resource availability, stronger radio link, lower latency, user preferences, or overall suitability to maintain uninterrupted Auracast broadcasting. The assistant of the first electronic device 602 may support system 700 in ranking and selecting the optimal target device 604A.

At operation 808, the system 700 inside the first electronic device 602 may transfer an Auracast configuration setting 810 of the first electronic device 602 to the target second electronic device 604A for switching the Auracast source role from the first electronic device 602 to the target second electronic device 604A. The Auracast configuration setting 810 may include broadcast identifiers, codec parameters, periodic advertisement configuration, synchronization details, authentication information, and other relevant broadcast attributes. Once the target second electronic device 604A receives the Auracast configuration setting 810, it may begin broadcasting the Auracast packets such that sink devices 606A-606C continue receiving audio streams without disruption.

The disclosure relates an operational-condition-triggered mechanism for handing over the Auracast source role from the first electronic device 602 to one of a plurality of second electronic devices 604A-604C. The system 700 operating within the first electronic device 602 may continuously monitor the operational status of the device. When internal thresholds associated with parameters such as battery level, wireless network signal strength, or application unavailability are reached, system 700 may proactively determine that continued Auracast broadcasting cannot be sustained and, therefore, initiate the handover procedure. This enables the system to respond before performance degradation affects listener experience.

Instead of relying on user input, the system 700 may independently detect an operational requirement, evaluate an associated severity against predefined limits stored or managed by system 700, and determine that a handover must be initiated. Such early-warning-based intervention allows the system to anticipate upcoming interruptions and seamlessly initiate a transition path. As a result, connected sink devices may continue receiving Auracast content without perceptible disruption, even as device 602 becomes increasingly constrained.

The ability of the first electronic device 602 to perform a direct transfer of a high-level Auracast configuration setting to a selected target second electronic device 604A is described. This configuration setting may include parameters such as the broadcast name, one or more broadcast identifiers, a codec wrapper, and a password, allowing device 604A to reproduce the broadcast context previously maintained by device 602. The collaboration between system 700 and system 700 may ensure that the configuration transfer is complete and secure, enabling device 604A to immediately assume source responsibilities.

The architecture supporting this mechanism may include a distinct two-tier device include one or more first electronic devices and a plurality of second electronic devices 604A-604C. The first electronic device 602 may serve as the currently active Auracast source role and may perform monitoring, evaluation, and device selection operations through the system 700. The second electronic devices 604A-606C may share or advertise capability-related information, enabling system 700 and the system 700 to measure comparative readiness and determine which device is best positioned to take over. This structured separation supports deterministic and predictable transitions.

Once the system initiates the handover, the first electronic device 602 may begin collecting capability information from the second electronic devices 604A-604C. This information may include each device's battery level, wireless network signal strength, content availability, and connectivity status, with system 700 optionally aggregating or validating these values. Based on these evaluations, system 700 may identify a target second electronic device 604A as the most suitable successor for continuing Auracast broadcasting. Upon selection, the high-level Auracast configuration setting may be transferred to device 604A, preparing it to assume the Auracast source role while preserving uninterrupted audio delivery.

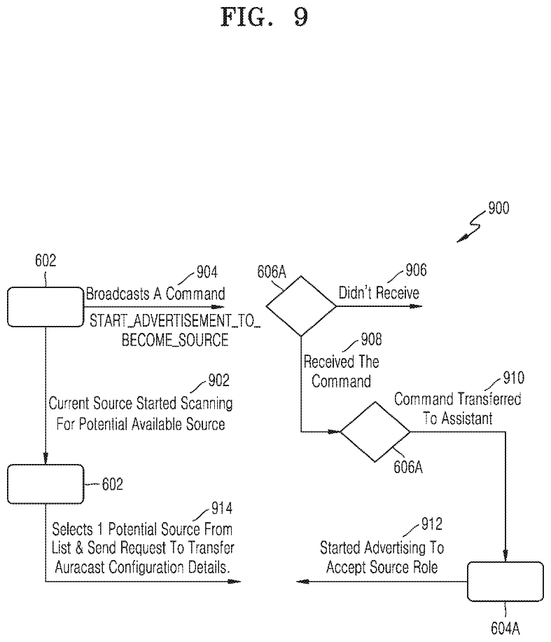

A detailed working of the aforementioned process will now be explained in greater detail below with reference to FIGS. 9 to 22.

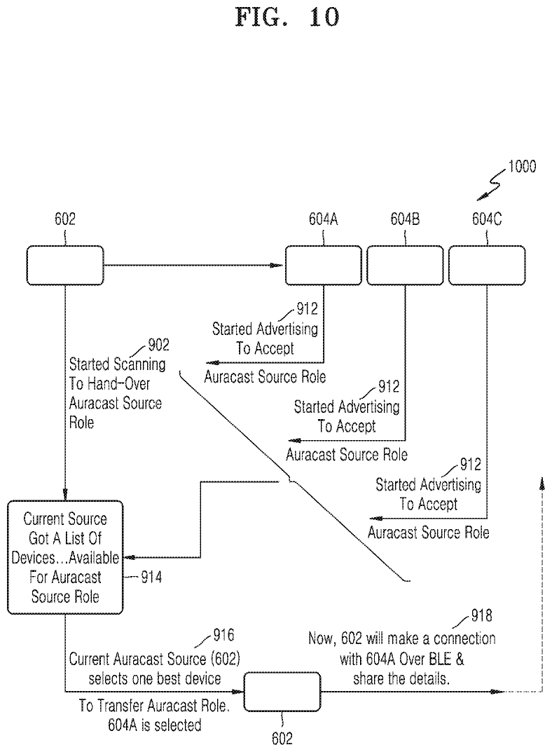

FIG. 9 is a flowchart illustrating example operations for identifying a potential electronic device capable of assuming an Auracast source role, according to an embodiment of the present disclosure. FIG. 10 is a flowchart illustrating example operations for identifying potential devices capable of becoming a new Auracast source, according to an example embodiment.

In the illustrated method, at operation 902, the system 700 inside the first electronic device 602, which operates as the current Auracast source, may detect an operational requirement to initiate a handover. Such operational requirement may relate to a low battery level, weak wireless network signal strength, or application unavailability of the first electronic device 602. Once detected, the system 700 may initiate scanning for candidate second electronic devices 604A-604C, while also preparing to broadcast instructions prompting those devices to announce their readiness.

At operation 904, the system 700 inside the first electronic device 602 may broadcast a command such as START_ADVERTISEMENT_TO_BECOME_SOURCE, transmitted over a wireless communication protocol. This command may instruct potential source devices to begin advertising availability so that system 700 may identify suitable candidates for taking over the Auracast source role. The command may also reach associated devices that may help in relaying or forwarding the message, improving its likelihood of reaching multiple candidates. In some instances, the broadcast command may be received by a sink device, such as 606A, and this evaluation may occur at operation 906. At operation 906, if the sink device 606A does not receive the command, the system 700 may continue scanning or rebroadcast the instruction. When the command is successfully received at operation 908, the sink device 606A may process it and serve as an intermediary for passing the instruction further within the local device environment.

At operation 910, the sink device 606A may transfer the received command to an assistant present inside one of the second electronic devices, such as second electronic device 604A. The assistant inside device 604A may then interpret the command as a request for readiness and may prepare second electronic device 604A to begin signaling its capability to become the next Auracast source. This may involve configuring advertisement parameters and initiating internal checks required to evaluate whether second electronic device 604A can assume the broadcast responsibilities.

At operation 912, second electronic devices such as 604A, 604B, and 604C may begin advertising to accept the Auracast source role. These advertisements may indicate that the devices are available, reachable, and technically capable of taking over the Auracast broadcast. Such advertisements may be transmitted using the same wireless communication protocol that links first electronic device 602, second electronic devices 604A-604C, and sink device 606A, ensuring interoperability.

At operation 914, the system 700 inside the first electronic device 602 may gather responses and advertisements from all available candidate devices and form a list of second electronic devices that may be capable of assuming the Auracast source role. The capability information provided by each of second electronic device 604A-604C may include one or more of: wireless network signal strength value, battery level, content availability, and connectivity status, enabling a detailed assessment of the suitability of each device for handover.

In an example, the first electronic device 602 may continue the scanning process at operation 902, while second electronic devices 604A-604C autonomously begin advertising at operation 912. In one example, such advertisements may not require a forwarded instruction and may be triggered when the candidate devices detect that a Auracast source is preparing for a role transition. This advertisement broadcast may allow system 700 to collect candidate information more rapidly.

Once the advertisements are received, the system 700 may again a list of available devices, and at step 916, the system inside the first electronic device 602 may select one best device to act as the new Auracast source. For example, the second electronic device 604A may be selected due to higher battery availability, stronger wireless connectivity, confirmed content availability, or superior connectivity status compared to 604B and 604C. This ensures that the selected device can provide stable and uninterrupted broadcasting after handover.

At operation 918, the system 700 inside the first electronic device 602 may establish a communication link with the selected second electronic device 604A using BLE, Bluetooth, QuickShare, near field communication (NFC), or Wi-Fi, depending on the capability of the devices. Through this connection, the first electronic device 602 may transfer the Auracast configuration setting, which may comprise a broadcast name, codec wrapper, one or more broadcast identifiers, and a password. These settings may enable second electronic device 604A to replicate the existing broadcast conditions, thereby preparing it to take over the Auracast source role without audio interruptions.

In an embodiment of the present disclosure, a negotiated and broadcast-driven workflow may be employed for handing over the Auracast source role from the first electronic device 602. In this case, the first electronic device 602, through the system 700, may broadcast a publicly detectable “switch-required” packet to all nearby devices, thereby declaring an intention thereof to relinquish the Auracast source role. Following this broadcast, the first electronic device 602 may scan for second electronic devices 604A-604C that “advertise willingness” to take over the source role. This willingness-based model enables only capable and consenting devices to participate, providing a more deliberate and structured discovery process.

Upon collecting advertisements from the plurality of second electronic devices 604A-604C, the first electronic device 602 may apply predetermined selection criteria, executed by system 700 under supervisory logic from system 100, to identify the best successor. The criteria may include multiple operational values such as wireless signal strength, battery level, content availability, and connectivity status. Once a successor is chosen illustratively the target second electronic device 604A the first electronic device 602 may retrieve detailed configuration parameters from its host and controller layers. These parameters may include sample rate, bit depth, offload configuration, streaming PHY, and QoS (host layer), as well as channel map, TX power, advertisement PHY, address type, periodic advertisement parameters, broadcast name, and broadcast identifiers (controller layer).

After gathering these detailed settings, the first electronic device 602 may transmit the complete configuration package to the target second electronic device 604A, enabling it to initialize an equivalent Auracast broadcast without disruption. Once second electronic device 604A confirms successful initialization, system 700 inside the first electronic device 602 may disable its own Auracast source role, ensuring a clean and collision-free transition. This confirmation-based disabling provides a seamless takeover, reducing audio gaps and ensuring uninterrupted listening across the connected devices.

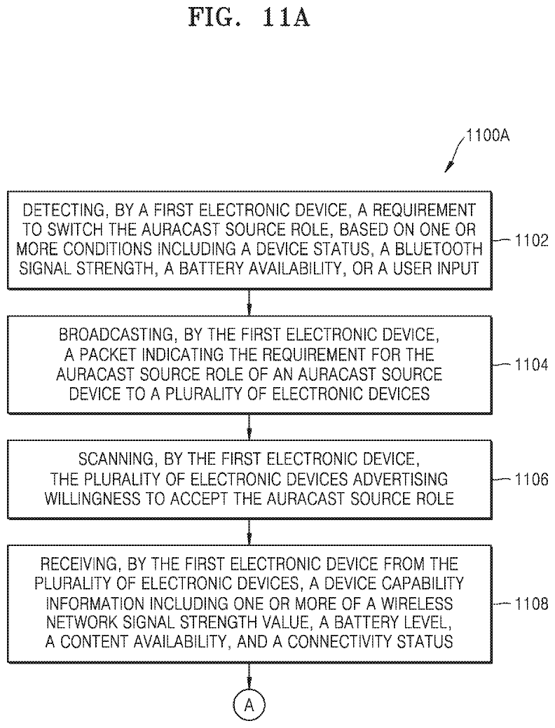

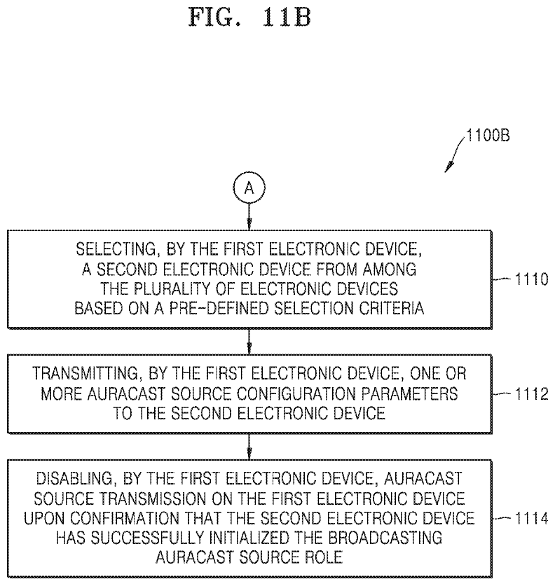

FIGS. 11A and 11B is a flowchart 1100A and 1100B illustrating an example method for switching Auracast source among a plurality of electronic devices, according to an example embodiment.

At operation 1102, the method may begin when the system 700 of the first electronic device 602, detects a requirement to switch the Auracast source role. This detection may be based on evaluating one or more conditions, such as a device status, a Bluetooth signal strength, a battery availability, or a user input received by the first electronic device 602. System 700 may periodically assess these internal and external conditions to determine whether the continued operation of device 602 as the Auracast source is sustainable. Upon determining that a threshold requirement is met, system 700 may autonomously trigger the role-switching workflow.

At operation 1104, in response to detecting the need for switching, the first electronic device 602, through system 700, may broadcast a packet indicating the requirement for switching the Auracast source role to a plurality of second electronic devices 604A-604C. This broadcast packet may serve as a public notification within the wireless environment, informing all reachable devices that the current Auracast source intends to relinquish its role. By transmitting this packet using a compatible wireless protocol, the first electronic device 602 may ensure that all nearby devices receive an opportunity to participate in the successor-selection process. In an example, the first electronic device 602 and the second electronic device 604A may not be connected directly, and the configuration may be shared as a part of BLE advertisement. In an example, the first electronic device 602 and the second electronic device 604A may not be connected at all, and both devices may communicate with a server to exchange configuration.

At operation 1106, the first electronic device 602, via the system 700, may scan the plurality of the second electronic devices 604A-604C to identify those advertising willingness to accept the Auracast source role. Each of the second electronic devices may broadcast advertisements or indicators signaling their readiness or interest in becoming the new Auracast source. The scanning performed by system 700 may thus filter and compile a list of devices capable of serving as potential successors.

At operation 1108, the first electronic device 602 may receive device capability information from the plurality of the second electronic devices 604A-604C that advertised willingness. The received capability information may include one or more parameters such as wireless network signal strength value, battery level, content availability, and connectivity status of each potential candidate device. System 700 may organize and evaluate these parameters so as to determine the relative suitability of each device for taking over the Auracast source role.

At operation 1110, using the collected capability information, the first electronic device 602, via the system 700, may select a second electronic device 604A from among the plurality of electronic devices based on a predefined selection criteria. The predefined selection criteria may involve evaluating multiple operational factors to ensure that the selected target device 604A is technically capable of providing uninterrupted and stable Auracast broadcasting. The selection mechanism may rely on comparative metrics to identify the most appropriate successor device.

At operation 1112, once the target second electronic device 604A has been selected, the first electronic device 602 may transmit one or more Auracast source configuration parameters to device 604A. These configuration parameters may include broadcast identifiers, synchronization information, codec-related details, advertisement settings, or other essential values necessary for initializing the Auracast source functionality. System 700 may manage the preparation and transfer of these parameters to ensure that second electronic device 604A can replicate the existing broadcast environment.

At operation 1114, upon receiving confirmation that the second electronic device 604A has successfully initialized and begun the broadcasting Auracast source role, the first electronic device 602, under the direction of system 700, may disable its own Auracast source transmission. This confirmation-based disabling ensures a safe transition by blocking simultaneous broadcasting by both devices. Thereafter, the Auracast session may continue seamlessly on device 604A, ensuring uninterrupted audio delivery to all connected sinks devices 606A-606C.

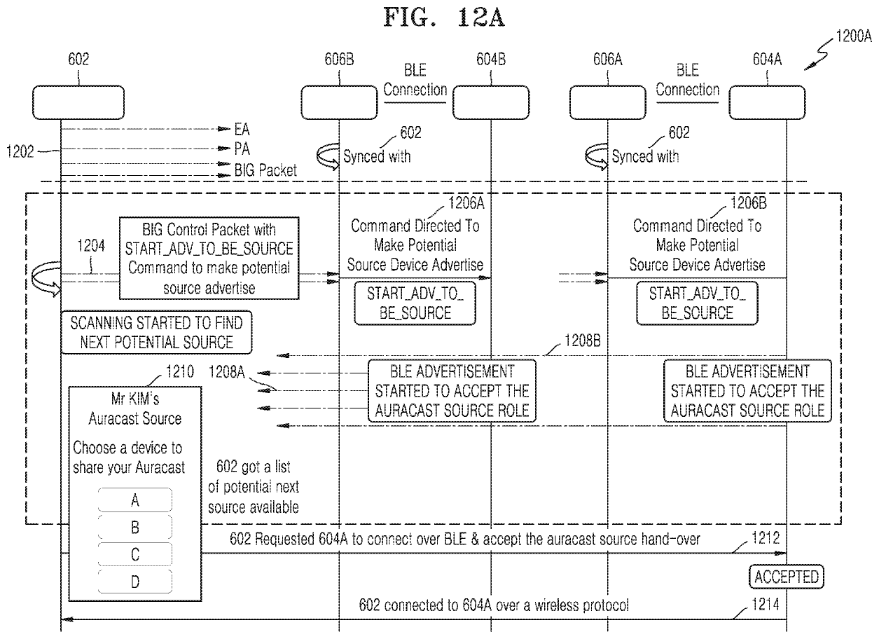

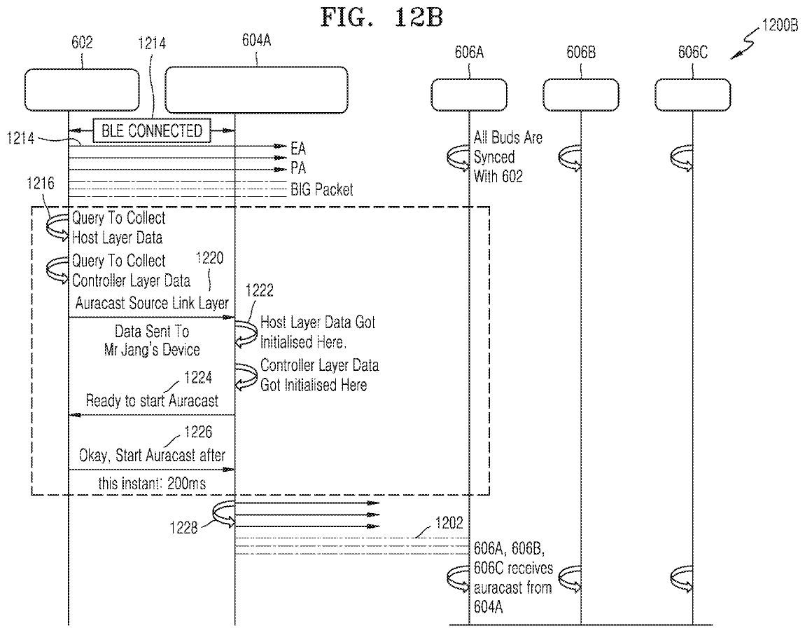

Details of aforementioned steps are provided with reference to FIGS. 12A and 12B.

FIGS. 12A and 12B are signal flow diagrams 1200A and 1200B illustrating an example call flow process for end-to-end procedure for switching an Auracast source role from a current Auracast source to a successor device while maintaining continuity for one or more listening devices, according to an example embodiment. In the example, the first electronic device 602 may initially operate as the current Auracast source and may broadcast Auracast data packets to a set of synchronized sinks devices 606A-606C, such as 606A, 606B, and 606C. The current Auracast source role on the first electronic device 602 may be managed by a system 700 within the device (and, in an embodiment, coordinated with a supervisory system 100). The call flow further depicts one or more candidate devices, such as 604B and 604A, that may be capable of assuming the Auracast source role upon handover. The operations shown may be executed such that listener devices remain synchronized to the broadcast and do not experience a perceptible audio interruption.

At operation 1202, the first electronic device 602 may continue broadcasting Auracast content while one or more sinks devices 606A-606C remain synchronized to the current source, and this broadcast operation may be performed by the broadcasting module 710. For example, the broadcasting module 710 may transmit one or more of EA (extended advertisements), PA (periodic advertisements), and BIG packet traffic associated with a broadcast isochronous group. Sink devices such as 606B and 606A may be shown as “synced with the first electronic device 602,” indicating that they may already be synchronized to the broadcast timing and identifiers of the current source. This baseline broadcast state may be maintained during the initial part of the handover so that the broadcast continues while candidates are solicited and evaluated. In some implementations, operation 1202 may occur concurrently with subsequent signaling, thereby avoiding interruption before the successor is prepared.

At operation 1204, the first electronic device 602 may generate and transmit a control instruction intended to solicit potential successor sources, and this transmission may be performed by the broadcasting module 710. The call flow depicts a BIG control packet that may carry or be associated with a command such as START_ADV_TO_BE_SOURCE, which may instruct potential successor devices to begin advertising willingness to accept the Auracast source role. In an embodiment, this solicitation may be broadcast-style signaling, which may be detectable by nearby devices and/or relayed by already synchronized sinks devices 606A-606C. The issuance of the control instruction by the broadcasting module 710 may occur while the current broadcast continues, thereby reducing interruption prior to successor readiness. In addition, system 100 may provide policy or threshold inputs that influence when such solicitation is triggered and how the solicitation is repeated or paced within the wireless environment.

At operation 1206A and operation 1206B, the command is being directed toward one or more device contexts that may become potential sources. In the illustrated example, operation 1206A may correspond to delivery of the START_ADV_TO_BE_SOURCE command toward a device context associated with 606B and 604B, and operation 1206B may correspond to delivery of the same command toward a device context associated with sink device 606A. In an embodiment, a sink device that is synchronized with 602 may receive the solicitation and relay it to an associated assistant or companion device 604A that can act as a successor source.

At operation 1208A and operation 1208B, one or more candidate devices may begin advertising willingness to accept the Auracast source role, and the call flow indicates that a BLE advertisement may be started to accept the Auracast source role. Candidate devices may include one or more second electronic devices such as 604A, 604B, and the willingness advertisements may be discoverable by the first electronic device 602 during a scanning window. In an embodiment, the advertisement may include a readiness indicator and may optionally include compact capability data or a pointer enabling the current source to query detailed capability information. The willingness advertisements may repeat periodically until a solicitation is withdrawn, a candidate is selected, or the candidate is otherwise notified to stop advertising.

At operation 1210, the system 700 of the first electronic device 602 may begin scanning for devices that are advertising willingness and may generate a list of available potential next sources, and these operations may be performed by a source selection module 712. The call flow indicates “SCANNING STARTED TO FIND NEXT POTENTIAL AURACAST SOURCE” and further indicates “a list of potential next source available.” In an embodiment, the list may be presented through a user interface that shows candidate devices and may allow user selection; however, selection may also be performed automatically based on internal policy implemented by the source selection module 712. The list may be generated by correlating advertisements received at operation 1208A/1208B with device identities and any capability information that is retrieved or inferred during scanning. The scanning at operation 1210 may be conducted while the broadcast transmission at operation 1202 continues, such that sinks devices 606A-606C remain uninterrupted while the next source is prepared.

At operation 1212, the first electronic device 602, via system 700, may request a selected target device illustratively target second electronic device 604A to connect over BLE and accept the Auracast source handover, and this request/selection workflow may be performed by the source selection module 714. The call flow indicates that “the first electronic device 602 Requested the second electronic device 604A to connect over BLE & accept the auracast source hand-over,” and also shows an “ACCEPTED” indication, which may represent that the second electronic device 604A acknowledges and accepts the request. This operation may represent a transition from broadcast-based solicitation to a directed unicast negotiation with a chosen successor. If acceptance is not received within a timeout interval, the source selection module 712 may select a different candidate from the list generated at operation 1210 and repeat the request procedure, thereby providing resiliency in candidate selection.

At operation 1214, the first electronic device 602 may establish a wireless connection with the target second electronic device 604A, and the call flow indicates that “the first electronic device 602 connected to the second electronic device 604A over a wireless protocol” and further depicts “BLE CONNECTED” between the first electronic device 602 and the second electronic device 604A. This BLE connection may serve as a secure and reliable channel for transferring configuration details and coordinating takeover timing. The system 700 may manage security parameters (e.g., encryption and authentication), service discovery, and connection quality to ensure the configuration transfer is not corrupted or intercepted. In an embodiment, the “wireless protocol” of operation 1214 may additionally or alternatively include Bluetooth BR/EDR, Wi-Fi, QuickShare, or NFC-assisted negotiation, but the illustrated flow emphasizes BLE connectivity for the handover exchange.

At operation 1216, after the connection is established, the first electronic device 602, via system 700, may query a host layer of the first electronic device 602 to obtain streaming configuration details, and such querying may be performed by the host layer module 714. The streaming configuration details may include one or more of sample rate, bits per sample, offload configuration, streaming Physical Layer (PHY), codec wrapper, and Quality of Service (QoS) configurations, and may be obtained based on the selected second electronic device 604A such that the parameters transferred are compatible with the second electronic device 604A and sufficient to maintain continuity of the Auracast stream. In the same operation 1216, the first electronic device 602, via system 700, may also query a controller layer of the first electronic device 602 to obtain broadcast configuration details, and such querying may be performed by the controller layer module 716. The broadcast configuration details may include one or more of channel map, transmit power, primary and secondary advertising PHY, address type, periodic advertisement parameters, broadcast name, and broadcast identifier, thereby capturing controller-level radio and advertising parameters required to replicate the broadcast behavior on the successor device.

At operation 1220, the first electronic device 602 may transmit, via the system 700, one or more Auracast source configuration parameters to the target second electronic device 604A over the established connection, and the call flow indicates “Auracast Source Link Layer Data Sent.” According to the disclosed embodiment, the one or more Auracast source configuration parameters transmitted at operation 1220 may be sent based on the obtained streaming configuration details and the broadcast configuration details collected at operation 1216. For example, the transmitted parameters may include the host-layer streaming configuration details (including one or more of sample rate, bits per sample, offload configuration, streaming PHY, codec wrapper, and QoS configurations) and the controller-layer broadcast configuration details (including one or more of channel map, transmit power, primary and secondary advertising PHY, address type, periodic advertisement parameters, broadcast name, and broadcast identifier), such that the target second electronic device 604A may initialize an equivalent Auracast source configuration. The transfer may be secured and may include acknowledgements or integrity checks to ensure that the configuration is delivered correctly and completely.

At operation 1222, the target second electronic device 604A may receive the transferred configuration and initialize its host-layer broadcast settings, as depicted by “Host Layer Data Got initialised Here.” In this operation, the target second electronic device 604A may apply the received streaming configuration details to initialize its broadcast pipeline. The target device may validate compatibility with its local hardware and software capabilities, and where deviations exist it may adapt parameters to supported equivalents while preserving intended broadcast behavior. This initialization may also include preparing application context, allocating buffers, and configuring codec instances so that the device is ready to generate broadcast-ready audio packets consistent with the session previously maintained by the first electronic device 602.

At operation 1224, the target second electronic device 604A may initialize its controller-layer parameters, as indicated by “Controller Layer Data Got initialised Here.” In this operation, 604A may configure radio parameters such as channel map, transmit power, primary and secondary advertising PHY, address type, and periodic advertisement scheduling so that its outgoing broadcast advertisements and isochronous packets match the expected timing and identity characteristics. Controller-layer initialization may also include configuring advertisement payload composition to reflect the broadcast name and broadcast identifier that sinks devices 606A-606C use for recognition and synchronization. This may be particularly useful for enabling sinks devices 606A-606C that were previously synced with 602 to continue receiving broadcast content with reduced disruption when the new source begins transmission.

At operation 1226, the target second electronic device 604A may indicate readiness to begin broadcasting and may coordinate a start time with the first electronic device 602. The call flow indicates “Ready to start Auracast” and includes an instruction such as “Okay, Start Auracast after this instant: 200 ms,” which may represent an example scheduling window used to align the transition. This coordination may allow the current source 602 to continue broadcasting until a controlled switchover moment, and may also allow the target second electronic device 604A to start broadcasting at a time that reduces or eliminates gaps for sinks devices 606A-606C. In an embodiment, the readiness message at operation 1226 may also function as the confirmation signal required for safe disabling of the current source, indicating that 604A has fully initialized both host and controller layers and is ready to assume the Auracast source role.

At operation 1228, the transition to the successor broadcast may be executed and packet continuity may be maintained by a packet update layer 718. In the illustrated embodiment, the packet update layer 718 may facilitate updating or re-pointing the broadcast packet flow such that sink devices 606A, 606B, and 606C receive Auracast packets from the target second electronic device 604A, as indicated by “606A, 606B, 606C receives auracast from 604A.” Upon confirmation that 604A has successfully initialized the broadcasting Auracast source role, the first electronic device 602, under control of system 700 (and optionally guided by system 100), may disable its own Auracast source transmission to prevent/reduce dual-source conflicts. This confirmation-based disabling may be performed such that periodic advertisements and broadcast isochronous transmissions from 602 are ceased in a controlled manner, while 604A continues the broadcast using the transferred configuration.

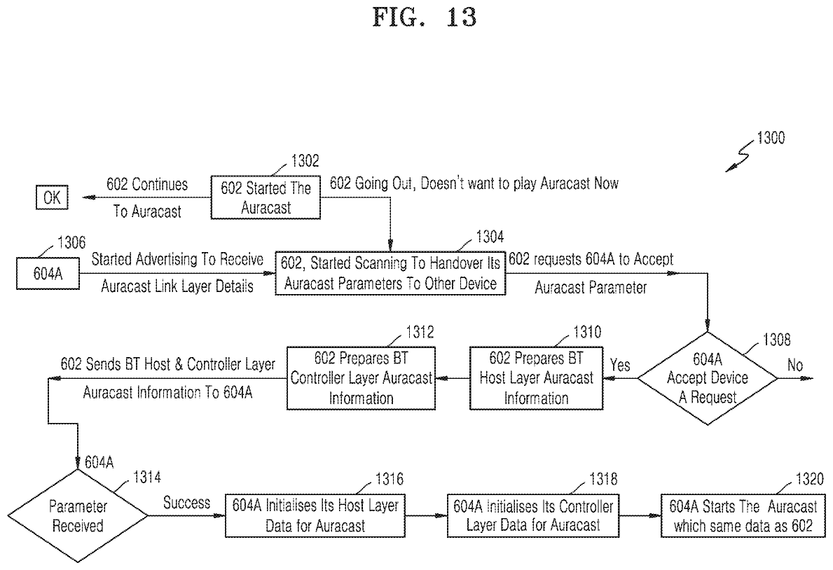

FIG. 13 is a diagram illustrating an example process flow 1300 for switching an Auracast source role from a first electronic device 602 (current Auracast source) to a second electronic device 604A, according to an example embodiment. The first electronic device 602 may execute the illustrated operations under control of system 700 (and optionally system 100) to reduce or eliminate audible gaps for sink devices that may be synchronized to device 602. The process flow 1300 may be used when device 602 is expected to stop playing or broadcasting Auracast and a seamless takeover is desirable. The labels and operation references shown in FIG. 13 may represent example stages of negotiation, configuration preparation, transfer, and takeover initialization.

At operation 1302, the first electronic device 602 may start an Auracast broadcast and may operate in an Auracast source role for one or more listener devices. In the illustrated path, device 602 may continue broadcasting while the system evaluates whether any switching is needed. If device 602 remains in a suitable operational state, the process may proceed along an “OK” path, and device 602 may continue to Auracast as indicated in the flow. This portion of the flow may represent a steady-state condition in which no handover is required. In such a steady state, the broadcast session parameters may remain unchanged.

At operation 1304, when device 602 is “going out” or otherwise does not want to play Auracast, the workflow may transition into a handover preparation state, and the broadcasting module 710 may perform the operations associated with operation 1304. In this operation, the broadcasting module 710 may initiate actions to enable switching of the Auracast source role, such as triggering solicitation signaling and/or initiating scanning behavior required for identifying a successor device. The broadcasting module 710 may execute this step while maintaining the ongoing broadcast for as long as possible, thereby preserving continuity for listeners. Operation 1304 may thus represent an operational change at device 602 that leads to successor discovery and preparation rather than immediate termination of broadcast.

At operation 1306, the second electronic device 604A may start advertising its willingness to receive Auracast link-layer details and to participate in a source takeover. This advertising may be discoverable by device 602 and may indicate that the second electronic device 604A is available and ready to accept the Auracast parameters required for continuing the same broadcast session. In an embodiment, the advertisement at operation 1306 may include a readiness indication and/or minimal capability signaling to allow device 602 to shortlist 604A as a takeover candidate. The willingness signaling by the second electronic device 604A may be performed over BLE or another wireless communication protocol supported by the devices.

Following the readiness advertising, the first electronic device 602 may begin scanning and may prepare to hand over its Auracast parameters to another device as depicted in the flow. In the illustrated example, device 602 may issue a request to the second electronic device 604A to accept Auracast parameters, and this request may result in a decision stage at operation 1308. At operation 1308, the second electronic device 604A may accept or reject the device request, for example based on its operational status, user policy, or capability constraints. If the second electronic device 604A does not accept the request (the “No” branch), device 602 may remain the source (or may attempt another candidate in an embodiment). If the second electronic device 604A accepts the request (the “Yes” branch), the workflow may proceed toward configuration preparation and transfer.

At operation 1310, the first electronic device 602 may prepare Bluetooth host-layer Auracast information, and the host control module 714 may perform the operations associated with operation 1310.

In this operation, the host control module 714 may obtain and package host-layer streaming configuration details that may be required to reproduce the broadcast session at device 604A. Such information may include stream-level parameters and higher-level configuration elements that influence audio pipeline behavior. The host control module 714 may prepare this information in a form suitable for transmission over the established wireless link with the second electronic device 604A.

At operation 1312, the first electronic device 602 may prepare Bluetooth controller-layer Auracast information, and the controller layer module 716 may perform the operations associated with operation 1312. The controller layer module 716 may obtain and package controller/radio parameters relevant to advertising and broadcast behavior, such as controller configuration values that influence periodic advertisements and transmission characteristics. After the host-layer information (operation 1310) and controller-layer information (operation 1312) are prepared, the first electronic device 602 may send the combined host and controller layer Auracast information to the second electronic device 604A, as indicated in the flow. FIG. 13 further reflects that the second electronic device 604A may receive the transferred parameters at the “parameter received” stage also labeled 1314, indicating successful delivery of the configuration payload.

Upon successful receipt of the configuration payload, the second electronic device 604A may proceed to initialize its internal Auracast source configuration using the received parameters. In the illustrated embodiment, the second electronic device 604A may initialize its host-layer data for Auracast (shown after the “success” outcome from the parameter receipt stage)(operation 1316), thereby preparing its audio pipeline and streaming configuration to match the broadcast context previously maintained by device 602. This initialization may include applying codec-related parameters, stream format settings, and other host-side values required to form broadcast-ready audio packets. Such initialization may occur while device 602 continues broadcasting, thereby allowing a controlled switchover timing.

At operation 1318, the second electronic device 604A may initialize its controller-layer data for Auracast. In this operation, the second electronic device 604A may apply controller-level parameters to configure advertising and radio transmission behavior consistent with the prior broadcast identity and timing. The controller-layer initialization may allow the second electronic device 604A to advertise and transmit Auracast packets in a way that supports continuity for sinks devices 606A-606C that were previously synchronized to device 602. Once controller-layer initialization is complete, 604A may be in a ready state to assume the Auracast source role without requiring listeners to manually reconfigure.

At operation 1320, the second electronic device 604A may start the Auracast broadcast using the same (or substantially the same) data and configuration context as the first electronic device 602. This step may represent the takeover point at which the second electronic device 604A assumes the broadcasting Auracast source role, thereby allowing device 602 to stop broadcasting or leave the session without disrupting listeners. In an embodiment, the transition may be coordinated such that the broadcast identity remains consistent for sinks devices 606A-606C, thereby reducing the likelihood of audible gaps.

All terminology (e.g., BIG event, BIS event, control subevent, BIG Control PDU, Opcode, broadcasting module 710) is retained.

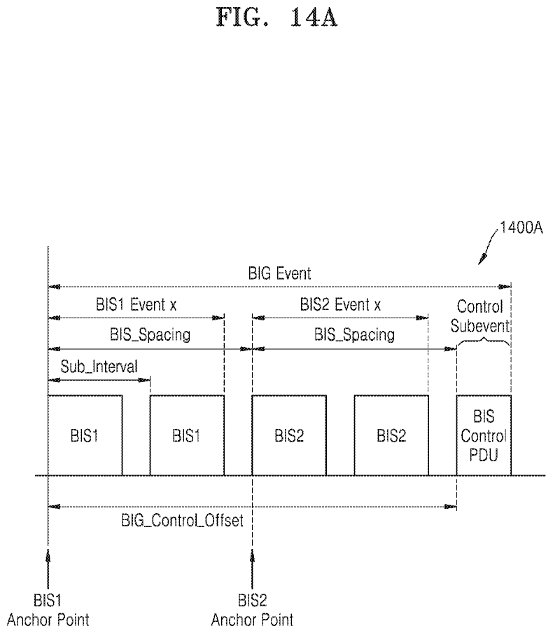

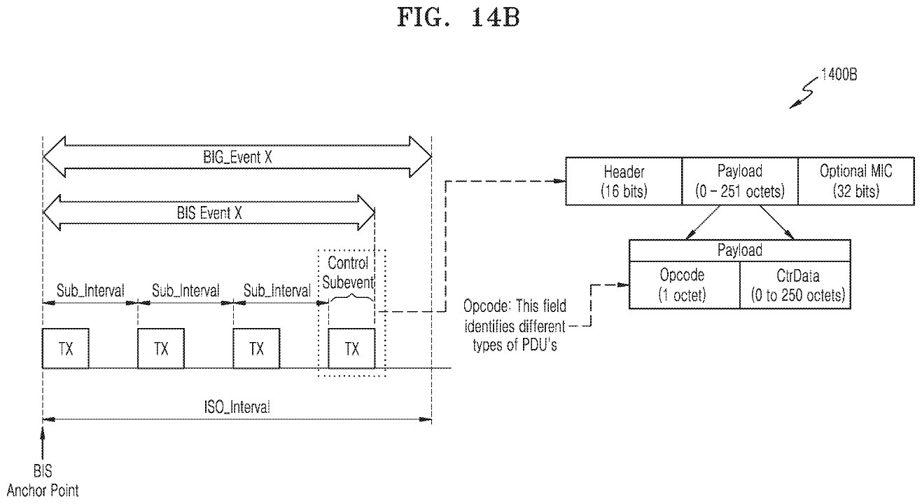

FIG. 14A is a timing diagram 1400A illustrating example timing structure of a Broadcast Isochronous Group (BIG) event, during which the broadcasting module 710 may transmit a sequence of Broadcast Isochronous Stream (BIS) PDUs, according to various example embodiments. As shown, a BIG event may include multiple BIS events (e.g., BIS1 event x and BIS2 event x) that may be spaced apart using a defined BIS_Spacing, with each BIS event itself divided into multiple Sub_Interval-based subevents. The BIS transmissions may occur at fixed BIS Anchor Points, allowing the broadcasting module 710 to follow predictable radio timing. This corresponds to the explanation that a BIS Data PDU may carry isochronous audio data and each BIG event may be comprised of several BIS events that maintain synchronization across receivers.

In addition to BIS transmissions, a BIG event may also contain a control subevent positioned relative to the BIG anchor point based on a BIG_Control_Offset, as illustrated in FIG. 14A. This control subevent may carry a BIG Control PDU, which may be used to deliver broadcast-wide control information to all synchronized receivers. The broadcasting module 710 may send the BIG Control PDU may be sent after all BIS subevents of the final BIS event. This sequencing may ensure that the isochronous audio content is delivered first, followed by system-level control signaling, maintaining both timing discipline and broadcast stability.

FIG. 14B is a diagram 1400B illustrating an example structure of a BIG Control PDU, which may include a Header (16 bits), a Payload (0-251 octets), and an optional Message Integrity Check (MIC) (32 bits), according to an example embodiment. Within the Payload, an Opcode (1 octet) may identify the control instruction type, while CtrData (0 to 250 octets) may carry specific parameters associated with that instruction. The Opcode field may identifies different types of PDU's. Thus, the broadcasting module 710 may populate the Opcode and CtrData fields to encode control operations that need to be processed by all sinks devices 606A-606C. The use of this PDU structure may allow consistent command dissemination without altering the surrounding BIS timing. An example opcode is as follows:

| Opcode | BIG Control PDU Name |
|---|---|
| 1-octet Opcode | START_ADV_TO_BE_SOURCE |

The broadcasting module 710 may use the control subevent of a BIG event to transmit a command that may trigger system-level actions among synchronized receivers. The selected material specifies that the BIG Control PDU may be used to tell commands to all the sink devices, and one such command may be START_ADV_TO_BE_SOURCE, which may instruct assistant devices 604A-604C to begin advertising willingness to accept Auracast source role. Once receivers decode the BIG Control PDU, they may propagate the instruction to associated assistant devices, causing them to advertise availability.

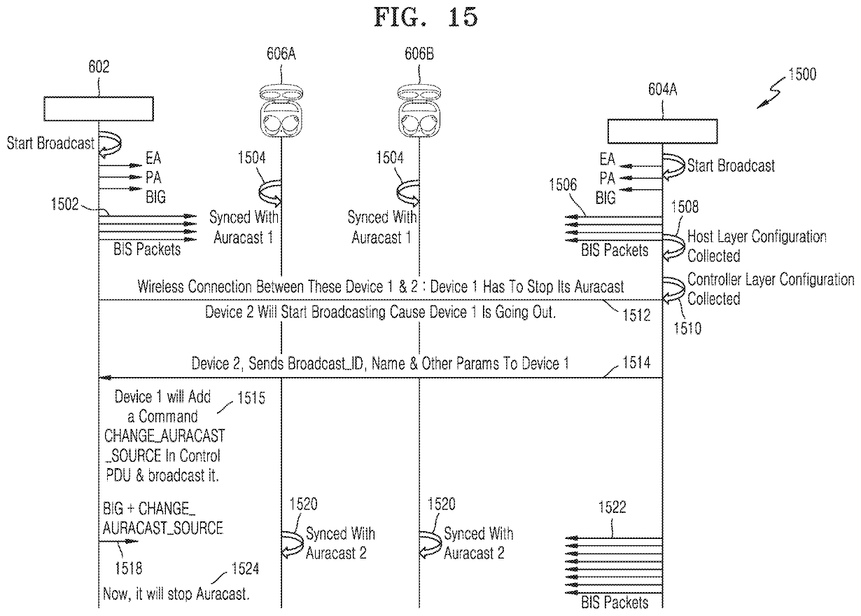

In an embodiment, the first electronic device 602 may be configured to provide configuration details to the second electronic device 604A to change the latter's configuration to achieve seamless transfer of the auracast source role. In an embodiment, the second electronic device 604A, upon being selected as for the auracast source role may begin its broadcast. Simultaneously, the second electronic device 604A may provide configuration details that the first electronic device 602A connected to others devices 606A-606C may provide it such devices 606A-606C to reconfigure themselves using the configuration details of the second electronic device 604A. An example is described in greater detail below with reference to FIG. 15.

FIG. 15 is a signal flow diagram illustrating an example call flow process 1500 in which an Auracast session may be transitioned from a current Auracast source to a successor device while preserving listening continuity for a plurality of electronic devices, illustrated as sink devices 606A and 606B according to an example embodiment. In an embodiment, a first electronic device 602 may initially operate as the current Auracast source, and a second electronic device 604A may be configured to assume the Auracast source role. The call flow may show how the first electronic device 602 may coordinate the transition by preparing successor-specific information, sending broadcast control signaling to sinks 606A and 606B, and then disabling its own source transmission only after confirmation that 604A has successfully initialized broadcasting.

At operation 1502, the first electronic device 602 may start broadcasting Auracast content and may transmit BIS Packets (and associated advertisement signaling such as EA/PA) establishing an initial broadcast context. This broadcast may define “Auracast 1” as the active broadcast session being rendered by sinks. The first electronic device 602 may continue emitting BIS Packets to provide continuous audio delivery while other transition-related actions are prepared in parallel.

At operation 1504, the sink devices 606A and 606B may be shown as “Synced with Auracast 1,” indicating that they may already be synchronized to the broadcast identifiers and timing of the first electronic device 602. In this state, sinks 606A and 606B may receive BIS Packets from the first electronic device 602 and may render the audio stream. This synchronized listening state may be preserved while the system prepares for a change in the Auracast source.

At operation 1506, the second electronic device 604A may start broadcasting (or may prepare to start broadcasting) a successor broadcast context associated with “Auracast 2.” In the illustrated flow, device 604A may begin emitting EA/PA and BIS-related transmissions so that an alternate broadcast context becomes available in the vicinity. This parallel preparation may allow sinks 606A and 606B to switch with minimal gap when instructed, because the successor broadcast may already be active or ready. At operation 1508, the second electronic device 604A may collect Host Layer Configuration for establishing broadcast continuity. Such host-layer configuration may align streaming parameters to ensure that the successor broadcast is compatible with the ongoing session expectations of the sinks. At operation 1510, the second electronic device 604A may also collect Controller Layer Configuration to align low-level advertising and radio characteristics for the successor broadcast. These host/controller preparations may enable 604A to act as a stable and compatible Auracast source.

At operation 1512, a wireless connection may be established between the first electronic device 602 and the second electronic device 604A to coordinate the transition. This connection may be used to exchange control intent, readiness information, and configuration details that enable the successor broadcast to be reliably initialized. The connection may also support a negotiated takeover where the first electronic device 602 may remain the active source until 604A indicates readiness.

At operation 1514, the devices may exchange a readiness/notification sequence indicating that the first electronic device 602 may be “going out” and that the second electronic device 604A is to be used as the successor. In an embodiment, the second electronic device 604A may provide to the first electronic device 602 one or more configuration parameters that correspond to, or are derived from, the previously transmitted Auracast source configuration parameters. These configuration parameters may include successor-identifying details (e.g., identifiers and timing hooks) that allow sinks 606A and 606B to switch to the second electronic device 604A deterministically. The first electronic device 602 may use these received configuration parameters to construct a broadcast control message for the sinks.

At operation 1515, the first electronic device 602 may create a command for the plurality of electronic devices (e.g., sinks 606A and 606B) based on the selected second electronic device 604A, wherein the command may comprise details of the second electronic device 604A. For example, the command may identify that 604A is the new Auracast source and may include the new source details required by the sinks for switching. The first electronic device 602 may then transmit this command over a broadcast channel to sinks 606A and 606B, thereby enabling simultaneous update of both sinks without requiring per-sink unicast signaling.

At operation 1518, the first electronic device 602 may transmit the command using a BIG control mechanism as “BIG+CHANGE_AURACAST_SOURCE”, and the command may be carried in a control Protocol Data Unit (PDU). The first electronic device 602 may insert the one or more configuration parameters received from the second electronic device 604A into the control PDU of the packet. This insertion may ensure that sinks 606A and 606B receive not only an instruction to switch, but also the successor-specific information required to locate, authenticate (if needed), and synchronize to the new broadcast context. Because the control PDU may be transmitted over the broadcast channel, the same switching payload may reach both sinks in a coordinated manner.

At operation 1520 and operation 1522, sinks 606A and 606B may transition from being “Synced with Auracast 1” to being “Synced with Auracast 2,” and may begin receiving BIS Packets from the second electronic device 604A. The sinks may use the details inserted into the control PDU to perform the switch in a deterministic sequence (e.g., detaching from old periodic advertising and attaching to new periodic advertising/BIS schedule). After the sinks are synchronized to 604A, the first electronic device 602 may treat this as confirmation that the second electronic device 604A has successfully initialized and assumed the broadcasting Auracast source role.

At operation 1524, the first electronic device 602 may disable (or may stop) Auracast source transmission upon confirmation that the second electronic device 604A has successfully initialized the broadcasting Auracast source role based on the one or more configuration parameters inserted into the control PDU. This confirmation-based disabling may reduce simultaneous dual broadcasting and may reduce the risk of audio gaps, because sinks 606A and 606B may already be receiving from 604A before 602 stops. In this manner, the call flow process 1500 may achieve a coordinated broadcast-to-broadcast transition where the current source provides a broadcast switching command carrying successor details, and only then disables its own source role after successful takeover.

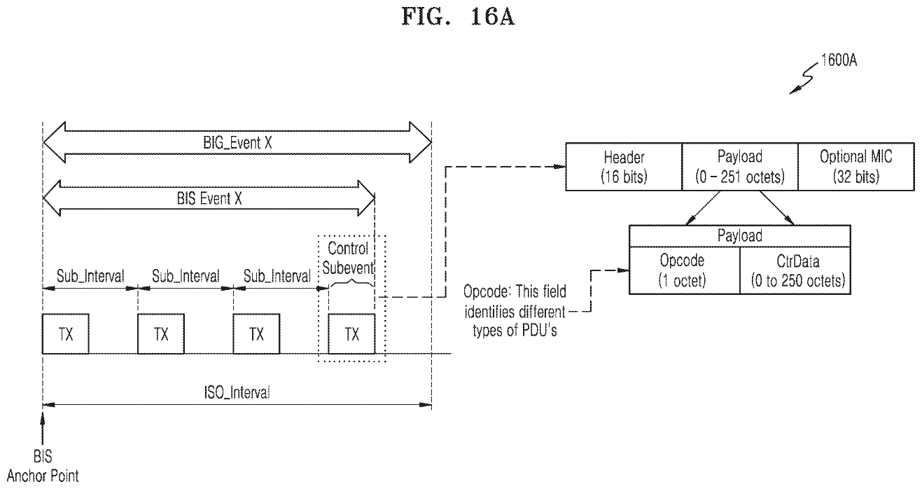

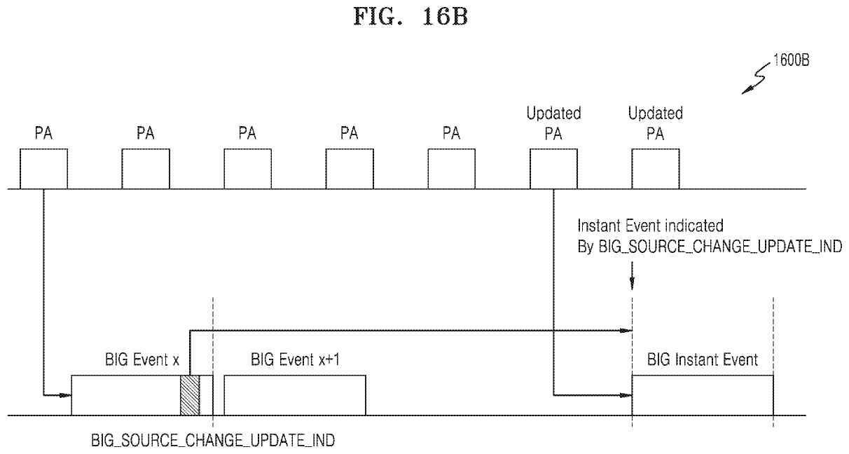

FIGS. 16A and 16B are diagrams illustrating an example of how a Broadcast Isochronous Group (BIG) event may be used by the broadcasting module 712 to indicate a change in Auracast source information during dynamic reconfiguration, according to an example embodiment. As shown in FIG. 16A, a BIG event may include multiple BIS subevents aligned under a BIS event, each transmitted at defined Sub_Intervals with a common BIS Anchor Point. In addition to BIS data transmissions, a BIG event may contain a control subevent, located relative to the BIG anchor by a BIG_Control_Offset, in which the broadcasting module 712 may transmit a BIG Control PDU. This structure aligns with the selected document stating that “each BIG event may contain a control subevent to send control information about the BIG,” thereby enabling synchronized receivers to respond uniformly to broadcast-level commands.

FIG. 16A may further depict the composition of the BIG Control PDU, which may include a 16-bit Header, a Payload of 0-251 octets, and an optional 32-bit MIC. Within the payload, an Opcode field (1 octet) may identify the control directive type, while a CtrData field (0-250 octets) may carry the associated parameters. The selected text explicitly notes: “Opcode: This field identifies different types of PDU's.” In this embodiment, the broadcasting module 710 may populate the Opcode with a command that signals updated Auracast source information, and may insert device- or stream-specific values into the CtrData field so that all synchronized receivers can interpret the source-change event reliably.

FIG. 16B may illustrate the time reference of a CHANGE_AURACAST_SOURCE event, indicating how synchronized devices may transition to a new Auracast source. As shown, periodic advertisements (PA) may occur during ongoing BIG events until a BIG Control PDU carrying the CHANGE_AURACAST_SOURCE instruction is transmitted. The figure shows that this instruction may occur at the end of BIG Event x, marked by a BIG_SOURCE_CHANGE_UPDATE_IND, after which an instant event may be defined. This instant event may represent the moment at which the successor configuration takes effect, matching the explanation that “BIG instant event is the event from which the stream will start transmitting with updated configuration.” Following this indication, the broadcast source may transmit Updated PA, which may carry the updated broadcast information.

The broadcasting module 710 makes use of this BIG Control PDU to broadcast control information. Once every sink device receives the BIG_Control_PDU with new command attached to it, every sink device will shift to NEW AURACAST automatically.” Consistent with this, FIGS. 16A and 16B may show how sink devices may shift their synchronization from the prior broadcast context to the newly updated broadcast context following reception of the CHANGE_AURACAST_SOURCE instruction. Assistant devices (e.g., 604A-604C) may accordingly update their internal state machines upon receiving the BIG Control PDU through the broadcast path, enabling seamless reconfiguration without user intervention.

| Opcode | BIG Control PDU Name |
|---|---|
| 1-octet Opcode | CHANGE_AURACAST_SOURCE |

Accordingly, FIGS. 16A and 16B together may demonstrate how the broadcasting module 710 utilizes the control subevent of a BIG event to transmit a CHANGE_AURACAST_SOURCE instruction and how sinks may update to the new broadcast context at a precisely defined BIG instant event. By integrating updated configuration details into the CtrData field and issuing Updated PA after the instant event, the broadcasting module 710 may ensure synchronized, network-wide adoption of new Auracast parameters across all listening devices. This coordinated mechanism supports dynamic reconfiguration of Auracast source information while maintaining the timing integrity and continuity of the broadcast stream.

In an embodiment of the present disclosure, a direct request reply takeover mechanism (based on user's manual initiation) may be employed in which a first Auracast source device (e.g., first electronic device 602) may simply transmit a request to one or more nearby electronic devices to determine whether any device is able and willing to assume the Auracast source role. In response, the nearby electronic devices may reply directly with capability information, thereby enabling a lightweight, point-to-multipoint negotiation model that may avoid complex solicitation broadcasts and extended scanning cycles. The first Auracast source device may then receive the replies, evaluate the reply content, and select a successor device that is best positioned to continue broadcasting with minimal delay.

In an embodiment, selection of a second Auracast source device (e.g., a selected second electronic device 604A) may be performed using a capability-driven decision based on the reply content. For example, each reply may include one or more parameters such as signal quality, battery availability, content availability, and connectivity status, allowing the first Auracast source device to select the most suitable successor under a predefined or simplified selection rule. After identifying the successor, the first Auracast source device may transfer Auracast source information to the selected device, where the Auracast source information may include host-layer configuration (e.g., streaming details such as sample rate, codec-related settings including a codec wrapper, and broadcast context such as broadcast identifiers) sufficient to reproduce the session.

Upon receiving the Auracast source information, the selected second Auracast source device may initiate broadcasting immediately, thereby creating a rapid, low-overhead handover scheme. This immediate start capability may reduce the likelihood of audio gaps by reducing the time between successor selection and successor broadcast activation. Accordingly, the direct request-reply model may provide a simple yet effective takeover approach in which the current source requests successors, successors compete via reply content, the current source selects a best candidate, and the newly selected source begins broadcasting with the transferred Auracast source information.

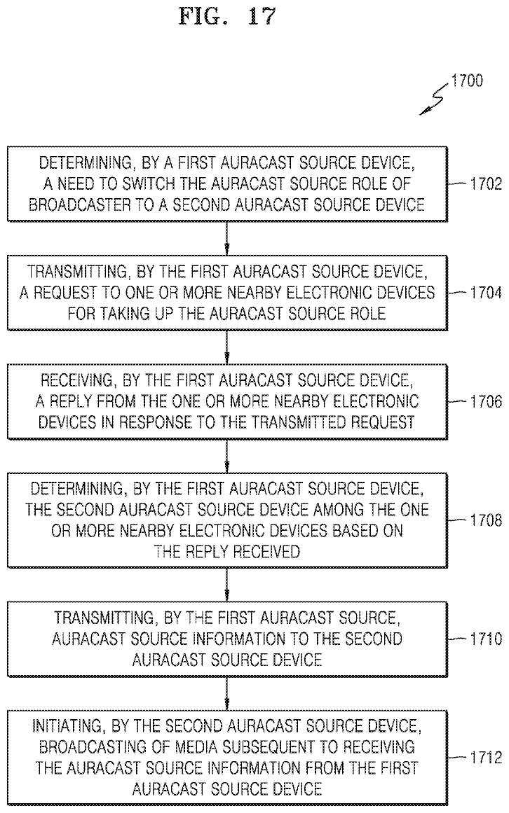

FIG. 17 is a flowchart illustrating an example method 1700 illustrating a direct request reply takeover procedure for switching an Auracast source role between electronic devices, according to an embodiment.

At operation 1702, the method 1700 may begin when a first Auracast source device 602 determines that there is a need to switch the Auracast source role of broadcaster to a second Auracast source device 604A. This determination may be based on one or more conditions that indicate reduced ability of device 602 to continue broadcasting reliably, such as an operational constraint, degraded link quality, or a system-level trigger. The first Auracast source device 602 may evaluate these factors and may conclude that a successor device should assume the Auracast source role to maintain uninterrupted playback.

At operation 1704, the first Auracast source device 602 may transmit a request to one or more nearby electronic devices for taking up the Auracast source role. The request may be transmitted using a lightweight solicitation mechanism that may ask nearby devices whether they are capable and willing to become the next Auracast source. This direct request may initiate a point-to-multipoint negotiation model and may enable multiple nearby devices to respond with their readiness and capability information.

At operation 1706, the first Auracast source device 602 may receive a reply from the one or more nearby electronic devices in response to the transmitted request. Each reply may indicate whether the responding device is available and may include associated device capability information such as a wireless network signal strength value, a battery level, a content availability status, and a connectivity status. The replies may allow the first Auracast source device 602 to assess the capability of the nearby devices and to determine which candidate is most suitable for succession.

At operation 1708, the first Auracast source device 602 may determine the second Auracast source device 604A from among the responding nearby devices based on the replies received and the associated capability information. The selection may use predefined criteria that may prioritize devices with better signal strength, higher battery level, confirmed content availability, or stronger connectivity status. Using this capability-driven evaluation, the first Auracast source device 602 may select 604A as the optimal successor.

At operation 1710, the first Auracast source device 602 may transmit Auracast source information to the second Auracast source device 604A. This Auracast source information may include host-layer configuration, sample rate, streaming details, a codec wrapper, and one or more broadcast identifiers, enabling the second Auracast source device 604A to initialize a broadcast configuration equivalent to that previously maintained by the first Auracast source device 602. This transfer may allow 604A to begin broadcasting without requiring a complete renegotiation of session parameters.

At operation 1712, the second Auracast source device 604A may initiate broadcasting of media subsequent to receiving the Auracast source information. Device 604A may begin transmitting BIS packets and associated advertisement signaling, enabling listener devices to seamlessly transition to the new broadcast without perceptible interruptions. The successful broadcast initiation by 604A may complete the takeover process, with device 604A fully assuming the Auracast source role.

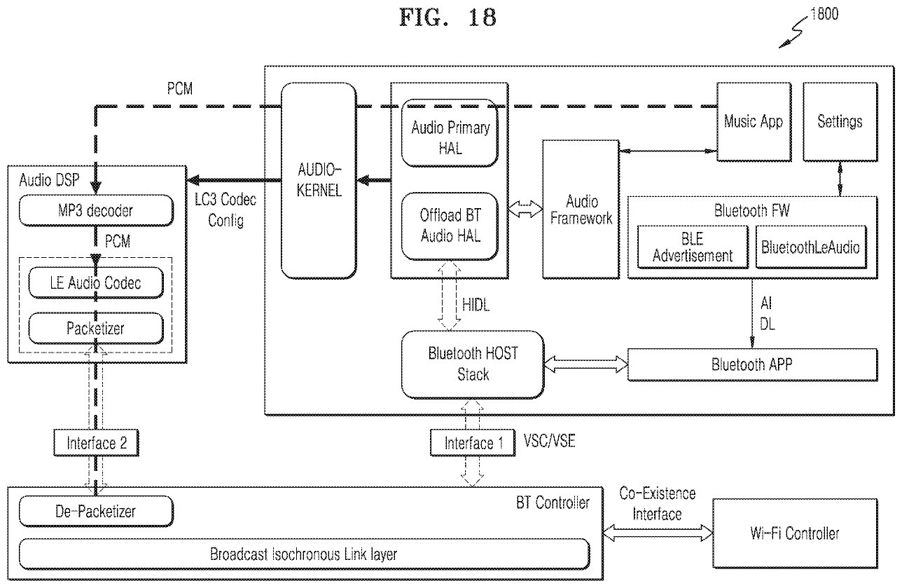

FIG. 18 is a diagram illustrating an example broadcast source architecture 1800 illustrating example modifications that may be implemented at an Auracast broadcast source such as the first electronic device 602 or the second electronic device 604A, wherein a broadcasting module 710 may be placed inside the BT Controller according to an example embodiment. In an embodiment, the BT Controller may incorporate the broadcasting module 710 as part of its link-layer operations, enabling the controller to autonomously generate or insert Control PDUs into the broadcast stream. These Control PDUs may carry information relating to a new Auracast, or may carry a command to switch to a new source, thereby enabling synchronized receivers to update their broadcast context without user intervention.

The architecture may further illustrate that the broadcast source may include multiple functional components across the Application Processor (AP) and the BT Controller. On the AP side, blocks such as the Audio DSP (containing an MP3 decoder, LE Audio codec, and packetizer), the AUDIO-KERNEL, the Audio Primary HAL, the Offload BT Audio HAL, and the Bluetooth HOST Stack may manage encoding, stream preparation, and host-side Bluetooth logic. Interface 1 may represent the interface between the Bluetooth HOST Stack in the AP and the BT Controller, allowing the BT Controller to communicate broadcast-critical parameters back to the host. As part of this communication, the BT Controller may start the broadcast and may send the Broadcast_ID to the Host layer, including channel map details, thereby enabling the host to maintain higher-layer awareness of broadcast configuration. The architecture may therefore illustrate that changes may occur at both the Bluetooth Host and Controller layers to support Auracast continuity and seamless source switching.

On the controller side, the Broadcast Isochronous Link Layer, a De-Packetizer, and a coexistence interface with a Wi-Fi controller may be included to manage low-level LE Audio broadcast operations. Because the broadcasting module 710 resides inside the BT Controller, it may be responsible for injecting link-layer Control PDUs that include commands such as updated Auracast information or switching instructions. As noted in the selected material, at the Link Layer, “the broadcasting module will add Control PDU which will be having information about new auracast or it will be sending command to switch to new source.” In this manner, FIG. 18 may illustrate a unified architecture in which host-side audio configuration and controller-side radio signaling cooperate to produce a synchronized, reconfigurable Auracast broadcast capable of seamless role transitions. Table below shows the architecture of the modifications at the broadcast source.

| Module | |
|---|---|
| (New/Modified) | Details |
| Bluetooth settings | a. On Source settings -> Start auracast Advertising or Share auracast Details |
| | Button may be seen. |
| BT | a. On Source Framework -> Source may be making changes in advertisement |
| APP/Framework | parameters, and it may advertise so that other devices can see it and make requests |
| | to become the next source. |
| BT Controller | a. Bluetooth Controller Layer may be having BT packet-related changes, it may |
| Layer | make changes to adjust CONTROL_PDU and one API may be implemented to |
| | share controller layer auracast configuration to the host layer. |
| BT Host Layer | a. It may be implementing an API to fetch auracast configuration details from the |
| | controller Layer. It may be also used to set the controller layer auracast |
| | configuration. |

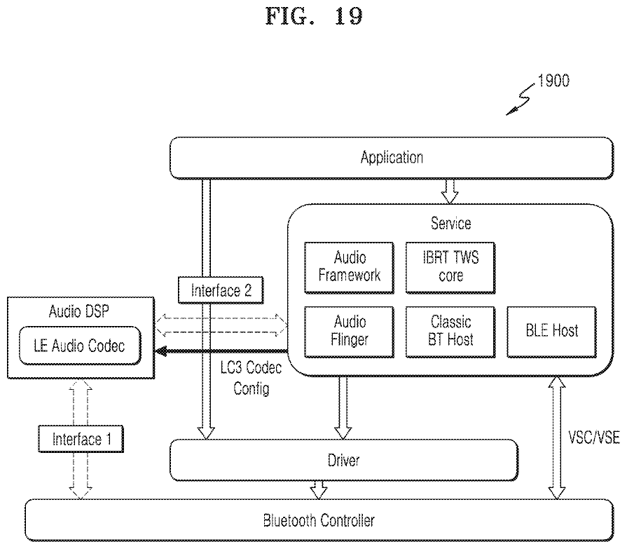

FIG. 19 is a block diagram 1900 illustrating example modifications at the broadcast sink device 606A-606C, according to an example embodiment. In the illustrated architecture, the sink device may include components distributed across the Application Processor (AP) side and the Bluetooth Controller side. On the AP side, the architecture may include an Application layer, a Service layer (with modules such as Audio Framework, IBRT TW S core, Audio Flinger, Classic BT Host, and BLE Host), and an Audio DSP containing an LE Audio Codec. These components may interact through Interface 2, which may carry LC3-coded configuration or audio control information between the Audio DSP and the AP services.

The block diagram may further include Interface 1, which may represent the interface between the BT Host in the Application Processor and the BT Controller. Through Interface 1, the Bluetooth Controller may start a broadcast (or broadcast-related signaling in the case of a sink) and may send the Broadcast_ID and channel map details up to the Host layer. This flow may support internal synchronization, assist-based functions, or transitions related to Auracast reconfiguration. As reflected in the figure and the underlying specification, changes may occur within both the Bluetooth Host layer and the Bluetooth Controller layer, enabling the sink to interpret metadata related to source switching and updated broadcast configurations.

| Module | |
|---|---|
| (New/Modified) | Details |
| BT | a. On SINK Framework -> Source may be making changes in advertisement |
| APP/Framework | parameters, and it may advertise so that other devices can see it and make requests |
| | to become the next source. |
| BT Controller | a. Bluetooth Controller Layer may be having BT packet-related changes, it may |
| Layer | make changes to adjust CONTROL_PDU and one API may be implemented to |
| | share controller layer auracast configuration to the host layer. |
| BT Host Layer | a. It may be implementing an API to fetch auracast configuration details from the |
| | Controller Layer. It may be also used to set the controller layer auracast |
| | configuration. |

At the Link Layer inside the Bluetooth Controller, the architecture may incorporate logic for adding a Control PDU to incoming or processed broadcast information. Such a Control PDU may contain information about a new Auracast or may include a command instructing the sink to switch to a new source, ensuring that the sink reacts quickly to broadcasts such as CHANGE_AURACAST_SOURCE transmitted by the upstream source device. Accordingly, FIG. 19 may illustrate how the sink-side Bluetooth Controller may receive advertisement and control information, process link-layer PDUs, and cooperate with Host-side services to update or reconfigure the Auracast listening session without requiring manual intervention by the user.

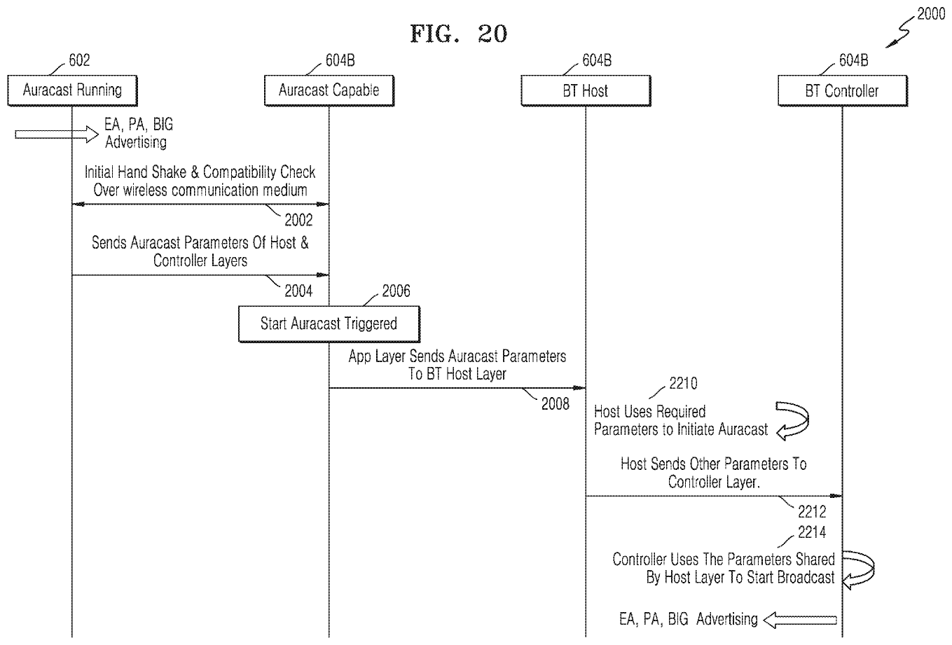

FIG. 20 is a signal flow diagram illustrating example call flow 2000 describing how Auracast broadcasting may be initiated on a second electronic device 604A using Auracast parameters transferred from a first electronic device 602, according to an example embodiment. The figure illustrates the timing and message exchanges among the broadcasting device 602, the capable successor device 604A, and its internal BT Host and BT Controller components as the Auracast session is transitioned. The flow aligns with prior embodiments in which layered configuration host layer first, controller layer second is used to enable seamless continuation of Auracast broadcasting.

At operation 2002, an initial handshake and compatibility check may occur between the first electronic device 602 and the second electronic device 604A over a wireless communication medium. During this initial exchange, device 602, which may already have Auracast running, may verify that device 604A is capable of receiving Auracast parameters and is ready for subsequent configuration. This compatibility check may ensure that both devices support required features, including LE Audio, LC3 codec support, periodic advertisement capability, and synchronized BIG advertisement parameters.

At operation 2004, the first electronic device 602 may send Auracast parameters of the host and controller layers to the second electronic device 604A. These parameters may include host-layer details such as sample rate, bits per sample, codec wrapper metadata, offload configuration, and QoS parameters, as well as controller-layer details such as channel map, primary and secondary advertising PHY, broadcast identifier, and transmit power. This transfer may allow 604A to construct an internal configuration that mirrors or is compatible with the configuration used by 602, thereby enabling consistent broadcasting behavior.

At operation 2006, after receiving the initial parameter set, the second electronic device 604A may trigger the Start Auracast sequence. This triggering may indicate that all essential host-side prerequisites have been satisfied and that the device may begin transitioning toward acting as an Auracast source. At this stage, only the application-layer readiness may be established, and further processing may be delegated to the internal Bluetooth stack components of 604A.

At operation 2008, the Application Layer of the second electronic device 604A may forward the received Auracast parameters to the BT Host layer. This includes forwarding the host-layer configuration fields received from 602 so that the BT Host stack can register, verify, and prepare them for controller-layer translation. The transfer through the application layer may also allow internal components such as the audio framework or BT Audio HAL to ensure appropriate mapping between stored values and device-specific capabilities.

At operation 2210, the BT Host of the second electronic device 604A may use the required subset of the received parameters to initiate Auracast. These required parameters may include the broadcast name, broadcast identifier, streaming PHY preferences, QoS profile, and codec wrapper. The BT Host may validate these values against local constraints and may begin constructing the advertising payload and protocol structures that will be used to initiate LE Audio broadcast operations.

At operation 2212, the BT Host of the second electronic device 604A may send other parameters typically controller-layer parameters to the Controller Layer. These may include low-level radio configuration values such as channel map, transmit power, address type, periodic advertisement interval, and other PHY-specific broadcast parameters. Sending these parameters to the controller may allow the BT Controller to prepare the precise radio scheduling environment required to support Auracast streams.

At operation 2214, the BT Controller of the second electronic device 604A may use the received parameters to start broadcasting, thereby generating EA, PA, and BIG advertising that are compatible with the session previously broadcast by device 602. This step may include establishing the isochronous transport context, scheduling BIG events, and preparing BIS packet emission. The BT Controller may act on configuration values from both host-layer and controller-layer elements to ensure timing accuracy and protocol compliance.

After broadcasting begins, the second electronic device 604A may transmit EA, PA, and BIS packets, as indicated on the right side of FIG. 20. These transmissions may represent that 604A is now acting as the active Auracast broadcaster. In this state, sink devices that were previously synchronized to the broadcast from 602 may begin receiving the new stream emitted by 604A, provided that their advertisement tracking and periodic sync parameters correspond to the identifiers configured at step 2214.

The first electronic device 602 may remain in Auracast-running state during the early steps of FIG. 20, transmitting EA, PA, and BIG advertising, as shown on the left side of the figure. This parallel operation may ensure that no audio discontinuity occurs until 604A fully initializes broadcasting. Only after receiving confirmation that 604A has successfully begun broadcasting may 602 optionally disable or stop its own Auracast operation, depending on the handover mechanism used.

According to the present disclosure, FIG. 20 may represent a layered transition model in which Auracast broadcasting is systematically transferred from 602 to 604A. Host-layer parameters may be transferred first, followed by controller-layer parameters, enabling a clean re-creation of the broadcast environment in the successor device. As a result, 604A may initiate broadcasting with minimal delay and without requiring sinks to rescan or reconfigure their paired or synchronized state.

FIG. 20 may illustrate how the coordinated interactions among the first electronic device 602, the second electronic device 604A, the BT Host, and the BT Controller may enable seamless Auracast transfer, preserving continuity and ensuring that the broadcast session may proceed smoothly with barely perceptible change at the sink device end.

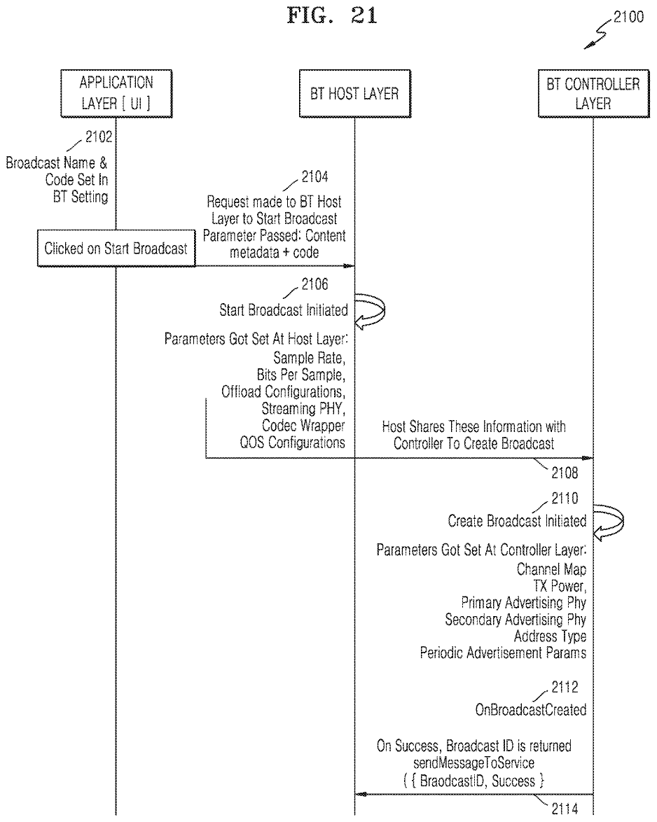

FIG. 21 is a signal flow diagram illustrating an example level architecture 2100 and an associated signal flow for starting an Auracast broadcast across an Application Layer (UI), a BT Host Layer (which may be operated by the host layer module 714) and a BT Controller Layer (which may be operated by the controller layer module 716), according to an example embodiment. The flow may show how user actions at the Application Layer may trigger host-layer broadcast initialization and how the host may provide required parameters to the controller layer for creating the broadcast. The figure may further show that, upon broadcast creation, a Broadcast ID may be returned back to the upper layers so that the broadcast context may be maintained for subsequent operations.

At operation 2102, the Application Layer (UI) may allow a user to configure broadcast metadata prior to initiating broadcast. For example, the UI may allow a Broadcast Name and Codec Set to be configured in BT settings, as indicated by “Broadcast Name & Codec Set in BT Setting 2102.” This step may establish the initial broadcast identity and codec selection information that the broadcast stack may use when creating the Auracast session. The UI configuration may therefore form the initial input for the host-side broadcast start request.

After the configuration at operation 2102, the user may initiate broadcast from the Application Layer, as depicted by a “Clicked on Start Broadcast” action. In response, the Application Layer may generate a request toward the BT Host Layer to start the broadcast. This request may be represented as “Request made to BT Host Layer to Start Broadcast 2104,” and it may convey the broadcast initiation intent from the UI into the Bluetooth host stack. The content of this request may include or reference the configured broadcast name and codec set.

At operation 2104, the BT Host Layer may receive the request from the Application Layer and may begin processing the parameters required for initiating the broadcast. The figure indicates that “Parameters Passed: Content metadata+codec,” which may refer, for example, to the Application Layer may provide content metadata and codec-related information to the host. The BT Host Layer may validate these inputs and may allocate resources for broadcast initiation. Host-side checks may ensure codec compatibility, support for LC3, and sufficient system resources exist for broadcast activation.

At operation 2106, the BT Host Layer may initiate the “Start Broadcast” procedure, shown as “Start Broadcast Initiated 2106.” In this stage, the host may assemble host-layer parameters required to define the broadcast streaming configuration. The figure lists example host-layer parameters that may be configured at the host, including sample rate, bits per sample, offload configuration, streaming PHY, codec wrapper, and QoS configurations. These may define the audio encoding format, transport behavior, and broadcast performance requirements.

The BT Host Layer may share the prepared information with the BT Controller Layer so that the controller may create and schedule the actual broadcast. This transfer may be reflected by the arrow labeled “Host Shares These Information with Controller to Create Broadcast 2108.” The host may provide controller-relevant parameters over the host-controller interface (e.g., HCl). These may include broadcast identity, PHY preferences, or timing attributes that the controller must enforce to begin periodic advertising and BIG scheduling.

At operation 2110, the BT Controller Layer may begin controller-side broadcast creation, as shown by “Create Broadcast Initiated 2110.” In this phase, the controller may configure radio parameters required for LE Audio broadcast operation. This may include allocating controller resources, preparing isochronous transport structures, and scheduling advertising events. The controller may validate the incoming configuration to ensure that all broadcast parameters meet Bluetooth LE Audio constraints.

At operation 2112, the BT Controller Layer may set or apply the controller-layer parameters necessary for the broadcast. The figure lists Channel Map, TX Power, Primary Advertising PHY, Secondary Advertising PHY, Address Type, and Periodic Advertisement Parameters as examples of parameters set at the controller. These settings may directly influence how advertisements and isochronous packets are transmitted over-the-air, and thus ensure that nearby Auracast receivers may detect, synchronize, and join the session.

Once the controller has successfully created the broadcast, a completion event may be generated, shown as “OnBroadcastCreated 2114.” This event may indicate that the controller-side configuration is finalized and that broadcast operation may begin. As part of this notification, the BT Controller Layer may return or expose the Broadcast ID, which uniquely identifies the broadcast session. The Broadcast ID may be used by the host for subsequent broadcast maintenance, source-switching workflows, or role transfer procedures.

After the Broadcast ID is received by the BT Host Layer, a message may be sent upward to the higher-level service or application logic. The figure shows an example message “sendMessageToService((BroadcastID, Success)),” which may inform the application that broadcast creation has succeeded. This may allow the Application Layer to display the updated broadcast state, begin advertisement of the broadcast session to other system components, and maintain session identity for the remainder of the Auracast transmission.

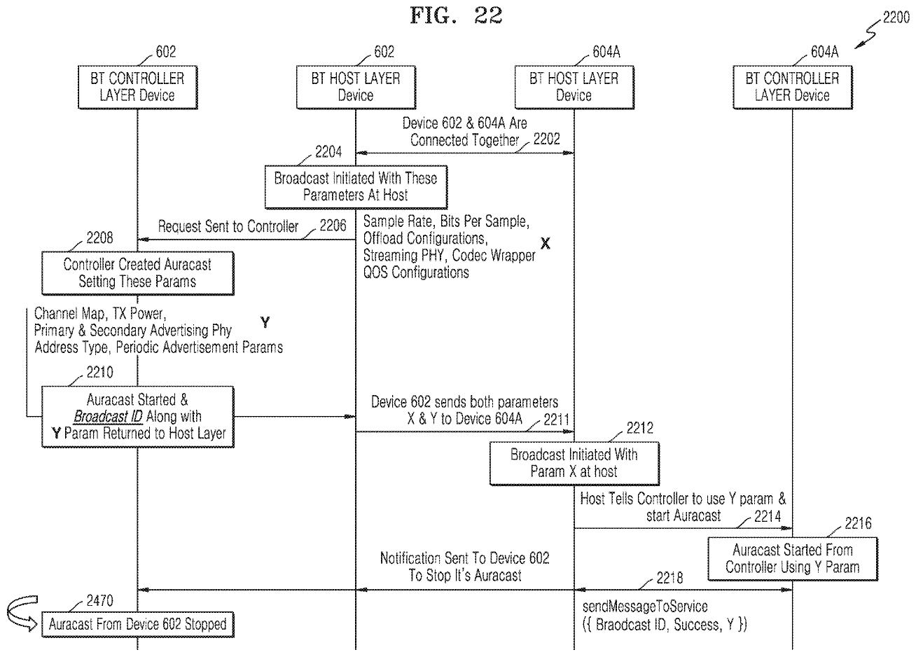

FIG. 22 is a signal flow diagram illustrating example call flow 2200 that may describe how a first electronic device 602 and a second electronic device 604A may cooperate to initiate a new Auracast broadcast and transfer complete host-layer and controller-layer configurations in a coordinated manner, according to an example embodiment. The figure may depict interactions among four functional blocks: BT Controller layer 716 and BT Host Layer 714 associated with the first electronic device 602, and BT HOST LAYER and BT CONTROLLER LAYER 604A associated with the second electronic device 604A. In this flow, the first electronic device 602 may initially operate as the broadcasting entity and may share its broadcast configuration with the second electronic device 604A so that device 604A may initiate a broadcast with equivalent settings.

At operation 2202, the first electronic device 602 and the second electronic device 604A may be connected together using a suitable wireless link that may support secure parameter exchange. This connection may be established prior to transferring broadcast configuration and may enable higher-layer negotiation, capability checks, and exchange of both host-layer and controller-layer configuration parameters. Establishing this communication path may be beneficial so that the first electronic device 602 may convey all required broadcast information to the second electronic device 604A without requiring repeated discovery or reconfiguration operations.

At operation 2204, the BT Host Layer 714 associated with the first electronic device 602 may begin broadcast initiation by setting a group of host-layer parameters, labeled as X, to define streaming behavior. The parameters X may include sample rate, bits per sample, offload configuration, streaming PHY, codec wrapper, and QoS configurations. The host layer may use these values to configure the streaming pipeline such that the audio path is prepared for broadcast-ready operation. Once the X parameters are configured, the BT Host Layer 714 may proceed to instruct its controller layer so that controller-side broadcast creation may be carried out.

At operation 2206, the BT Host Layer 714 of the first electronic device 602 may send a request to the BT Controller layer 716 to create and start Auracast using the host-layer parameters X. This request may be interpreted as an instruction to allocate broadcast resources and prepare controller-side radio scheduling for periodic advertisements and isochronous transmissions. The controller layer may transition into a setup state in which it prepares to configure channel maps, advertising PHYs, periodic advertisement scheduling, and BIG/BIS timing primitives needed for Auracast operation.

At operation 2208, the BT Controller layer 716 associated with the first electronic device 602 may set controller-layer Auracast configuration details labeled Y As shown in the figure, the Y parameters may include channel map, TX power, primary and secondary advertising PHY, address type, and periodic advertisement parameters. These controller-layer values may define how advertisements and isochronous packets are transmitted over-the-air, including power, PHY selection, and periodic advertisement behavior. Applying Y may complete controller-side preparation so that the broadcast instance may be started and identified using a broadcast identifier.

At operation 2210, the BT Controller layer 716 may start Auracast on the first electronic device 602 and may return a Broadcast ID along with the controller-layer parameters Y to the BT Host Layer 714. This return may allow the host layer to maintain awareness of the broadcast identity and the controller-side configuration that was used to create the broadcast. The Broadcast ID may uniquely identify the created Auracast session and may be reused for subsequent coordination or transfer procedures. Returning Y to the host may further enable the host to forward controller-relevant parameters to the second electronic device 604A for recreating a compatible broadcast context.

At operation 2211, the first electronic device 602 may send both X parameters and Y parameters to the second electronic device 604A, thereby transferring the complete host-layer and controller-layer configuration context. This transfer may be performed over the connection established at operation 2202 and may include the Broadcast ID, streaming configuration details, codec wrapper information, and controller-side advertisement and radio parameters. By sending both X and Y, the first electronic device 602 may allow the second electronic device 604A to reconstruct an Auracast broadcast that is consistent with the broadcast characteristics established by device 602.

At operation 2212, the BT HOST LAYER of the second electronic device 604A may initiate broadcast setup using the received host-layer parameters X, as reflected by “Broadcast initiated with X Param set by host 2212.” In this stage, the host layer may configure sample rate, bits per sample, offload behavior, streaming PHY preferences, codec wrapper, and QoS settings to align with the original broadcast configuration. This host-side initialization may prepare the second electronic device 604A to drive controller-side broadcast creation using the corresponding controller-layer parameters.

At operation 2214, the BT HOST LAYER may instruct the BT CONTROLLER LAYER 604A to use the controller-layer parameter set Y and start Auracast. This step may represent the host-to-controller transfer on the second electronic device 604A, where controller-level values such as channel map, TX power, advertising PHYs, address type, and periodic advertisement parameters are provided to the controller. By reusing Y, the second electronic device 604A may align its low-level advertising and broadcast timing behavior with the previously established broadcast context from the first electronic device 602.

At operation 2216, the BT CONTROLLER LAYER 604A may start Auracast from the controller using the Y parameters, as reflected by “Auracast started from Controller using Y Param 2216.” In this state, the second electronic device 604A may begin emitting the broadcast advertisements and isochronous transmission structures needed for Auracast operation. The second electronic device 604A may thereby assume the role of a broadcaster with configuration consistent with that of the first electronic device 602, allowing receivers to discover and synchronize to the new broadcast context.

At operation 2218, a notification may be sent to the first electronic device 602 to stop its Auracast broadcast, as reflected by “Notification sent to Device A to stop its Auracast 2218,” where Device A may correspond to the first electronic device 602 in this embodiment. This notification may be transmitted after the second electronic device 604A has successfully initialized and started broadcasting, thereby supporting a confirmation-based disabling behavior. The notification may help avoid dual-source conflicts and may reduce the likelihood of an audio gap by ensuring that the new source is active before the old source is stopped.

At operation 2470, the call flow may indicate that Auracast from the first electronic device 602 may be stopped, as reflected by “Auracast from Device A stopped 2470,” where Device A may correspond to device 602. Following this stop, the second electronic device 604A may remain as the active broadcaster, and its host layer may send a success notification such as sendMessageToService((BroadcastID, Success, Y)), indicating that the broadcast has been created and started using the transferred configuration. In this manner, the flow may depict a coordinated transition in which device 604A begins broadcasting with the transferred X and Y configuration before device 602 ceases its own broadcast operations.

According to the present disclosure, the system may provide a proactive and/or automatic handover capability wherein the first electronic device may detect an operational requirement (e.g., battery depletion, connectivity degradation, user intent, or related triggers) and may initiate a source-role handover before service interruption occurs. By switching the Auracast source role based on one or more conditions, the system may anticipate upcoming failures and may reduce the likelihood of an abrupt broadcast stop that would otherwise impact all synchronized listeners simultaneously.

According to the present disclosure, the system may reduce or eliminate the need for each listener to manually perform repeated reconnection steps, thereby avoiding an N×(multiple steps) burden in group listening scenarios. Because the current source may transfer key broadcast settings (e.g., broadcast identifiers, synchronization/advertisement parameters, codec configuration, and authentication information such as passwords) to a selected successor source, sinks and associated assistants may continue to recognize and follow the broadcast context without requiring every user to rescan and re-enter credentials. This may be particularly advantageous for private/password-protected broadcasts where several operations per user are otherwise required.

According to the present disclosure, the system may improve handover robustness and selection quality by enabling discovery of candidate successor devices and selecting a target device based on capability information such as battery level, signal strength, content availability, and connectivity status. This capability-driven selection may help ensure that the chosen device is best positioned to maintain uninterrupted broadcasting and may allow the system to adaptively choose the most suitable successor in real time, rather than relying on ad hoc manual selection.

While at least various example embodiments have been presented in the foregoing detailed description, it should be appreciated that a vast number of variations exist.

Further, while the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method for switching Auracast source among a plurality of electronic devices, the method comprising:
detecting, by a first electronic device in an Auracast source role of an Auracast source device from among a first electronic device and a plurality of second electronic devices, an operational requirement to handover the Auracast source role of the Auracast source device to any one of the plurality of second electronic devices;
receiving, by the first electronic device, a device capability information from each of the plurality of second electronic devices;
identifying, by the first electronic device, a target second electronic device for handing over the Auracast source role of the Auracast source device; and
transferring, by the first electronic device, an Auracast configuration setting of the first electronic device to the target second electronic device for switching the Auracast source role from the first electronic device to the second electronic device.

2. The method of claim 1, wherein the operational requirement comprises one or more of a battery level of the first electronic device, a wireless network signal strength of the first electronic device, and an application unavailability of the first electronic device.

3. The method of claim 1, wherein first electronic device and the plurality of second electronic devices communicate with each other via a wireless communication protocol.

4. The method of claim 1, wherein the device capability information from each of the plurality of second electronic devices comprises one or more of a wireless network signal strength value, a battery level, a content availability, and a connectivity status.

5. The method of claim 1, wherein the Auracast configuration setting comprises a broadcast name, a codec wrapper, one or more broadcast identifiers, and a password.

6. The method of claim 1, further comprising:
broadcasting, by the first electronic device, a packet indicating the requirement for the Auracast source role of an Auracast source device to a plurality of electronic devices;
scanning, by the first electronic device, the plurality of electronic devices advertising willingness to accept the Auracast source role.

7. The method of claim 1, further comprising:
transmitting, by the first electronic device, one or more Auracast source configuration parameters to the second electronic device; and
disabling, by the first electronic device, Auracast source transmission on the first electronic device upon confirmation that the second electronic device has successfully initialized the broadcasting Auracast source role.

8. The method of claim 7, wherein the transmitting the one or more Auracast source configuration parameters to the second electronic device comprises:
querying, by the first electronic device, a host layer of the first electronic device to obtain streaming configuration details, including one or more of sample rate, bits per sample, offload configuration, streaming Physical Layer (PHY), codec wrapper, and Quality of Service (QoS) configurations based on the selected second electronic device;
querying, by the first electronic device, a controller layer of the first electronic device to obtain broadcast configuration details including one or more of channel map, transmit power, primary and secondary advertising PHY, address type, periodic advertisement parameters, broadcast name, and broadcast identifier; and
transmitting, by the first electronic device, one or more Auracast source configuration parameters to the second electronic device based on the obtained streaming configuration details and the broadcast configuration details.

9. The method of claim 7, wherein the one or more Auracast source configuration parameters comprise host layer configuration, sample rate, streaming details, a codec wrapper, and one or more broadcast identifiers.

10. The method of claim 6, further comprising:
creating, by the first electronic device, a command for the plurality of electronic devices based on the selected second electronic device from among the plurality of electronic devices, wherein the command comprises details of the second electronic device; and
transmitting, by the first electronic device, the command over a broadcast channel to the plurality of electronic devices.

11. A first electronic device for switching Auracast source among a plurality of electronic devices, the system comprising:
a memory;
at least one processor, comprising processing circuitry, operatively coupled to the memory, wherein at least one processor, individually and/or collectively, is configured to cause the first electronic device to:
detect an operational requirement to handover the Auracast source role of the Auracast source device to any one of the plurality of second electronic devices;
receive a device capability information from each of the plurality of second electronic devices;
identify a target second electronic device for handing over the Auracast source role of the Auracast source device; and
transfer an Auracast configuration setting of the first electronic device to the target second electronic device for switching the Auracast source role from the first electronic device to the second electronic device.

12. The first electronic device of claim 11, wherein the operational requirement comprises one or more of a battery level of the first electronic device, a wireless network signal strength of the first electronic device, and an application unavailability of the first electronic device.

13. The first electronic device of claim 11, wherein the first electronic device and the plurality of second electronic devices are configured to communicate with each other via a wireless communication protocol.

14. The first electronic device of claim 11, wherein the device capability information from each of the plurality of second electronic devices comprises one or more of a wireless network signal strength, a battery level, a content availability, and a connectivity status.

15. The first electronic device of claim 11, wherein the Auracast configuration setting comprises a broadcast name, a codec wrapper, one or more broadcast identifiers, and a password.

16. The first electronic device of claim 11, wherein at least one processor, individually and/or collectively, is configured to cause the first electronic device to:
broadcast a packet indicating the requirement for the Auracast source role of an Auracast source device to a plurality of electronic devices;
scan the plurality of electronic devices advertising willingness to accept the Auracast source role.

17. The first electronic device of claim 11, wherein at least one processor, individually and/or collectively, is configured to cause the first electronic device to:
transmit one or more Auracast source configuration parameters to the second electronic device; and
disable Auracast source transmission on the first electronic device upon confirmation that the second electronic device has successfully initialized the broadcasting Auracast source role.

18. The first electronic device of claim 17, wherein to transmit the one or more Auracast source configuration parameters to the second electronic device, at least processor, individually and/or collectively, is configured to cause the first electronic device to:
query a host layer of the first electronic device to obtain streaming configuration details, including one or more of sample rate, bits per sample, offload configuration, streaming Physical Layer (PHY), codec wrapper, and Quality of Service (QoS) configurations based on the selected second electronic device;
query a controller layer of the first electronic device to obtain broadcast configuration details including one or more of channel map, transmit power, primary and secondary advertising PHY, address type, periodic advertisement parameters, broadcast name, and broadcast identifier (ID); and
transmit one or more Auracast source configuration parameters to the second electronic device based on the obtained streaming configuration details and the broadcast configuration details.

19. The first electronic device of claim 17, wherein the one or more Auracast source configuration parameters comprise host layer configuration, sample rate, streaming details, a codec wrapper, and one or more broadcast identifiers.

20. The first electronic device of claim 16, wherein at least processor, individually and/or collectively, is configured to cause the first electronic device to:
create a command for the plurality of electronic devices based on the selected second electronic device from among the plurality of electronic devices, wherein the command comprises details of the second electronic device; and
transmit the command over a broadcast channel to the plurality of electronic devices.
